(19) United States
(12) Patent Application Publication
(10) Pub. No.: US 2025/0242204 A1
(43) Pub. Date: Jul. 31, 2025

(54) USER EXPERIENCE SYSTEMS FOR A ROWING MACHINE

(71) Applicant: PELOTON INTERACTIVE, INC., New York, NY (US)

(72) Inventors: Apostolos KOTTAS, New York, NY (US); Steve SANBEG, Piscataway, NJ (US); Kevin WINN, New York, NY (US); Wong Kun NG, Brooklyn, NY (US); David William PETRILLO, Leonia, NJ (US); Marissa VIVORI, New York, NY (US); Ben MCCALLUM, New York, NY (US); Scott WORTHINGTON, New York, NY (US); Alex COHEN, New York, NY (US); Randy ROTH, New York, NY (US); Molly WARD, New York, NY (US); Nick BREESER, New York, NY (US); Tom Mudgett MEJIA, New York, NY (US); Zhao LI, New York, NY (US); Hardik THAKKAR, New York, NY (US)

(21) Appl. No.: 18/856,736

(22) PCT Filed: Apr. 14, 2023
(86) PCT No.: PCT/US2023/065798

§ 371 Date: Oct. 14, 2024

Related U.S. Application Data
(60) Provisional application No. 63/331,027, filed on Apr. 14, 2022.

(51) Int. Cl. A63B 24/00; A63B 22/00; A63B 71/06

(52) U.S. Cl. CPC A63B 24/0062; A63B 22/0076; A63B 71/0622; A63B 2024/0068; A63B 2071/065; A63B 2220/13; A63B 2225/50

(57) ABSTRACT

Various systems and methods that enhance an exercise activity performed by a user are described. In some embodiments, a rowing machine is described. The rowing machine can enhance the user experience of a user performing a rowing activity using the rowing machine, such as during a rowing-based exercise class. For example, the rowing machine can include different sensors that capture information associated with a position or movement of a seat of the rowing machine relative to a position or movement of a handle of the rowing machine and utilize the captured information to perform actions associated with the user performing the rowing activity.

### CROSS-REFERENCE TO RELATED APPLICATIONS

This application claims priority to U.S. Provisional Patent Application No. 63/331,027, filed on Apr. 14, 2022, entitled USER EXPERIENCE SYSTEMS FOR A ROWING MACHINE, which is hereby incorporated by reference in its entirety.

This application is related to PCT Application No. PCT/US2022/077979, filed on Oct. 12, 2022, entitled ROWING MACHINE, which is hereby incorporated by reference in its entirety.

### BACKGROUND

The world of connected fitness is an ever-expanding one. This world can include a user taking part in an activity (e.g., running, cycling, lifting weights, and so on), other users also performing the activity, and other users doing other activities. The users may be utilizing a fitness or exercise machine (e.g., a treadmill, a stationary bike, a strength machine, a stationary rower, and so on), or may be moving through the world on a bicycle or other machine.

An exercise machine, such as a rower, can include a display device or display that includes a user interface providing or presenting interactive content to the users. For example, the user interface can present live or recorded classes, video tutorials of activities, online or interactive games, augmented reality environments, leaderboards and other competitive or interactive features, progress indicators (e.g., via time, distance, and other metrics), and so on.

### BRIEF DESCRIPTION OF THE DRAWINGS

Embodiments of the present technology will be described and explained through the use of the accompanying drawings.

FIG. 1 is a block diagram illustrating a suitable network environment for users of a connected fitness platform.

FIGS. 2A-2B are diagrams illustrating an example rowing machine.

FIG. 3A is a block diagram illustrating components of a rowing machine.

FIG. 3B is a flow diagram illustrating an example method for performing an action using rowing machine data.

FIGS. 3C-3D depict a visualization of an avatar representing a user on a rowing machine.

FIG. 3E depicts a visualization that identifies a form error for a user.

FIG. 4 is a block diagram illustrating components of a form system.

FIGS. 5A-5D are diagrams illustrating a user performing a rowing activity using a rowing machine.

FIGS. 6A-6F are diagrams illustrating charts that map seat data to handle data for a rowing machine.

FIGS. 7A-7B are diagrams that illustrate a graphical representation of a user performing a rowing activity.

FIG. 8 is a flow diagram illustrating a method for performing an action based on movement of a seat relative to a handle of a rowing machine.

FIG. 9 is a flow diagram illustrating a method for rendering a graphical representation of a user of a rowing machine.

FIG. 10 is a diagram that depicts a graphical representation of a user of a rowing machine.

FIGS. 11A-11D are diagrams illustrating user interfaces that facilitate the onboarding of users to participate in a rowing class.

FIGS. 11E-11F are diagrams illustrating user interfaces shown to a user before a class starts.

FIGS. 12A-12D are diagrams illustrating user interfaces displayed during a rowing class.

FIG. 13 is a diagram illustrating a user interface that depicts a graphical representation of a user performing a rowing activity.

In the drawings, some components are not drawn to scale, and some components and/or operations can be separated into different blocks or combined into a single block for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### Overview

Various systems and methods that enhance an exercise activity performed by a user are described. In some embodiments, a rowing machine is described. The rowing machine includes devices and/or components that can enhance the experience of a user performing a rowing activity via the rowing machine, such as during a rowing-based exercise class.

In some embodiments, a form system, or form helper system or form assist system, can utilize data from a rowing machine to perform actions that inform or assist a user of a rowing machine, such as assist the user by identifying and/or correcting form errors while the user is performing a rowing activity.

The form system, in some cases, may continuously and/or periodically receive data during the rowing activity, and render a graphical representation of the user that depicts the user performing the rowing activity. The graphical representation may depict movement of different body parts of the user (e.g., legs, arms, torso) in relation to one another, and/or overlay the representation with an ideal or baseline rowing movement, presenting the user with visual feedback during their rowing activity.

Thus, the form system can perform actions based on measuring and/or tracking movement of a seat of the rowing machine relative to the handle of the rowing machine. The actions can include identifying a part of a stroke performed by the user, detecting errors or issues with a current form of the user during the rowing activity, tracking the movement of the user during the rowing activity, rendering a visualization (e.g., a displayed avatar) of the user during the rowing activity, and so on.

Thus, in some embodiments, the rowing machine and/or form system can utilize data measured from a rowing machine to assist the user with performing a rowing activity, such as helping, assisting, and/or otherwise giving instructions to the user to better their form and improve as a rower, among other benefits.

Various embodiments of the rowing machine, including associated systems and methods, will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of a Suitable Exercise Platform

The technology described herein is directed, in some embodiments, to providing a user with an enhanced user experience when performing an exercise activity, such as an exercise activity as part of a connected fitness system or other exercise system. For example, a user (e.g., a member of a connected fitness platform) can perform a rowing activity via a rowing machine, such as a stationary rower having an electromechanical or magnetic drivetrain, an air-based flywheel, a water-based mechanism, and so on.

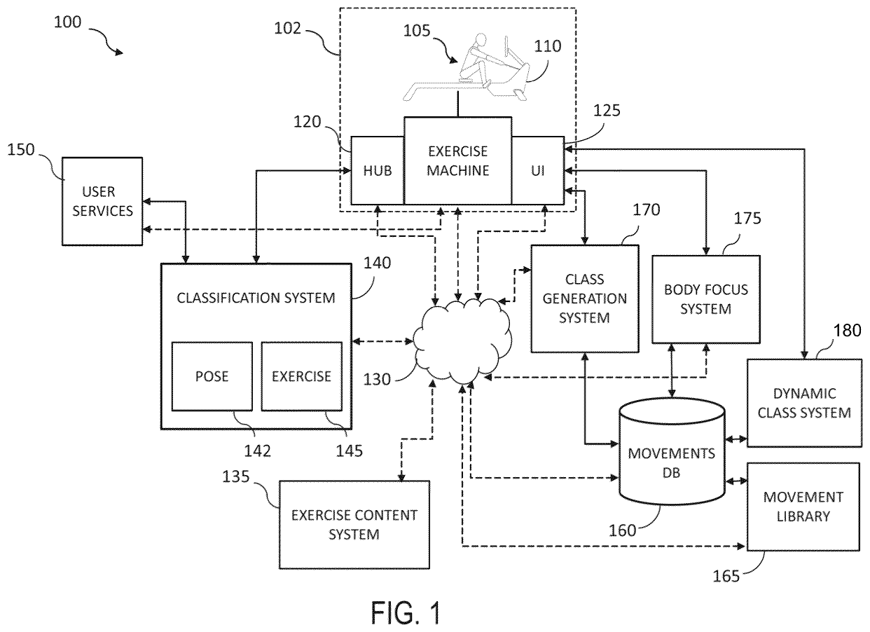

FIG. 1 is a block diagram illustrating a suitable network environment 100 for users of an exercise system. The network environment 100 includes an activity environment 102, where a user 105 is performing an exercise activity, such as a rowing activity. In some cases, the user 105 can perform the rowing activity with an exercise machine 110, which can be a stationary rower or rowing machine.

In addition, the user 105 can perform other exercise activities, including a variety of different workouts, activities, actions, and/or movements, such as movements associated with stretching, doing yoga, lifting weights, rowing, running, cycling, jumping, sports movements (e.g., throwing a ball, pitching a ball, hitting, swinging a racket, swinging a golf club, kicking a ball, hitting a puck), and so on.

The exercise machine 110 can assist or facilitate the user 105 to perform the movements and/or can present interactive content to the user 105 when the user 105 performs the activity. For example, in some cases, the exercise machine 110 can be a stationary bicycle, a treadmill, a weight machine, or other machines. As another example, the exercise machine 110 can be a display device that presents content (e.g., classes, dynamically changing video, audio, video games, instructional content, and so on) to the user 105 during an activity or workout.

The exercise machine 110 includes a media hub 120 and a user interface 125. The media hub 120, in some cases, captures images and/or video of the user 105, such as images of the user 105 performing different movements, or poses, during an activity. The media hub 120 can include a camera or cameras, a camera sensor or sensors, or other optical sensors configured to capture the images or video of the user 105.

In some cases, the media hub 120 can capture audio (e.g., voice commands) from the user 105. The media hub 120 can include a microphone or other audio capture devices, which captures the voice commands spoken by a user during a class or other activity. The media hub 120 can utilize the voice commands to control operation of the class (e.g., pause a class, go back in a class), to facilitate user interactions (e.g., a user can vocally “high five” another user), and so on.

In some cases, the media hub 120 includes components configured to present or display information to the user 105. For example, the media hub 120 can be part of a set-top box or other similar device that outputs signals to a display, such as the user interface 125. Thus, the media hub 120 can operate to both capture images of the user 105 during an activity, while also presenting content (e.g., streamed classes, workout statistics, and so on) to the user 105 during the activity.

The user interface 125 provides the user 105 with an interactive experience during the activity. For example, the user interface 125 can present user-selectable options that identify live classes available to the user 105, pre-recorded classes available to the user 105, historical activity information for the user 105, progress information for the user 105, instructional or tutorial information for the user 105, and other content (e.g., video, audio, images, text, and so on), that is associated with the user 105 and/or activities performed (or to be performed) by the user 105.

The exercise machine 110, the media hub 120, and/or the user interface 125 can send or receive information over a network 130, such as a wireless network. Thus, in some cases, the user interface 125 is a display device (e.g., attached to the exercise machine 110), that receives content from (and sends information, such as user selections) an exercise content system 135 over the network 130. In other cases, the media hub 120 controls the communication of content to/from the exercise content system 135 over the network 130 and presents the content to the user via the user interface 125.

The exercise content system 135, located at one or more servers remote from the user 105, can include various content libraries (e.g., classes, movements, tutorials, games, virtual environments, and so on) and perform functions to stream or otherwise send content to the machine 110, the media hub 120, and/or the user interface 125 over the network 130.

In addition to a machine-mounted display, the display device 125, in some embodiments, can be a mobile device associated with the user 105. Thus, when the user 105 is performing activities outside of the activity environment 102 (such as running, climbing, and so on), a mobile device (e.g., smart phone, smart watch, or other wearable device), can present content to the user 105 and/or otherwise provide the interactive experience during the activities.

In some embodiments, a classification system 140 communicates with the media hub 120 to receive images and perform various methods for classifying or detecting poses, motions, and/or exercises performed by the user 105 during an activity. The classification system 140 can be remote from the media hub 120 (as shown in FIG. 1) or can be part of the media hub 120.

The classification system 140 can include a pose detection system 142 that detects, identifies, and/or classifies poses performed by the user 105 and depicted in one or more images captured by the media hub 120. Further, the classification system 140 can include an exercise detection system 145 that detects, identifies, and/or classifies exercises or movements performed by the user 105 (e.g., different parts of a rowing stroke) and depicted in the one or more images captured by the media hub 120.

Various systems, applications, and/or user services 150 provided to the user 105 can utilize or implement the output of the classification system 140 and/or data collected by the exercise machine 110, as described herein.

In some embodiments, the systems and methods include a movements database (dB) 160. The movements database 160, which can reside on a content management system (CMS) or other system associated with the exercise platform (e.g., the exercise content system 135), stores information as entries that relate individual movements to data associated with the individual movements. As is described herein, a movement is a unit of a workout or activity, and in some cases, the smallest unit of the workout or activity. Example movements include a push-up or a jumping jack or a bicep curl or portion of a rowing stroke.

The movements database 160 can include, or be associated with, a movement library 165. The movement library 165 includes short videos (e.g., GIFs) and long videos (e.g., ˜90 seconds or longer) of movements, exercises, activities, and so on. Thus, in one example, the movements database 160 can relate a movement to a video or GIF within the movement library 165.

Various systems and applications can utilize information stored by the movements database 160. For example, a class generation system 170 can utilize information from the movements database 160 when generating, selecting, and/or recommending classes for the user 105, such as classes that target specific muscle groups.

As another example, a body focus system 175 can utilize information stored by the movements database 160 when presenting information to the user 105 that identifies how a certain class or activity strengthens or works the muscles of their body. The body focus system 175 can present interactive content that highlights certain muscle groups, displays changes to muscle groups over time, tracks the progress of the user 105, and so on.

Further, a dynamic class system 180 can utilize information stored by the movements database 160 when dynamically generating a class or classes for the user 105. For example, the dynamic class system 180 can access information for the user 105 from the body focus system 175 and determine one or more muscles to target in a new class for the user 105. The system 180 can access the movements database 160 using movements associated with the targeted muscles and dynamically generate a new class for the user that incorporates videos and other content identified by the database 160 as being associated with the movements.

FIG. 1 and the components, systems, servers, and devices depicted herein provide a general computing environment and network within which the technology described herein can be implemented. Further, the systems, methods, and techniques introduced here can be implemented as special-purpose hardware (for example, circuitry), as programmable circuitry appropriately programmed with software and/or firmware, or as a combination of special-purpose and programmable circuitry. Hence, implementations can include a machine-readable medium having stored thereon instructions which can be used to program a computer (or other electronic devices) to perform a process. The machine-readable medium can include, but is not limited to, floppy diskettes, optical discs, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media/machine-readable medium suitable for storing electronic instructions.

The network or cloud 130 can be any network, ranging from a wired or wireless local area network (LAN), to a wired or wireless wide area network (WAN), to the Internet or some other public or private network, to a cellular (e.g., 4G, LTE, or 5G network), and so on. While the connections between the various devices and the network 130 and are shown as separate connections, these connections can be any kind of local, wide area, wired, or wireless network, public or private.

Further, any or all components depicted in the Figures described herein can be supported and/or implemented via one or more computing systems or servers. Although not required, aspects of the various components or systems are described in the general context of computer-executable instructions, such as routines executed by a general-purpose computer, e.g., mobile device, a server computer, or personal computer. The system can be practiced with other communications, data processing, or computer system configurations, including: Internet appliances, hand-held devices, wearable devices, or mobile devices (e.g., smart phones, tablets, laptops, smart watches), all manner of cellular or mobile phones, multi-processor systems, microprocessor-based or programmable consumer electronics, set-top boxes, network PCs, mini-computers, mainframe computers, XR/AR/VR devices, gaming devices, and the like. Indeed, the terms “computer,” “host,” and “host computer,” and “mobile device” and “handset” are generally used interchangeably herein and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible non-transitory computer-readable storage media), including magnetically or optically readable computer discs, hard-wired or preprogrammed chips (e.g., EEPROM semiconductor chips), nanotechnology memory, or other data storage media. Indeed, computer implemented instructions, data structures, screen displays, and other data under aspects of the system may be distributed over the Internet or over other networks (including wireless networks), or they may be provided on any analog or digital network (packet switched, circuit switched, or other scheme). Portions of the system may reside on a server computer, while corresponding portions may reside on a client computer such as an exercise machine, display device, or mobile or portable device, and thus, while certain hardware platforms are described herein, aspects of the system are equally applicable to nodes on a network. In some cases, the mobile device or portable device may represent the server portion, while the server may represent the client portion.

### Examples of a Suitable Rowing Machine

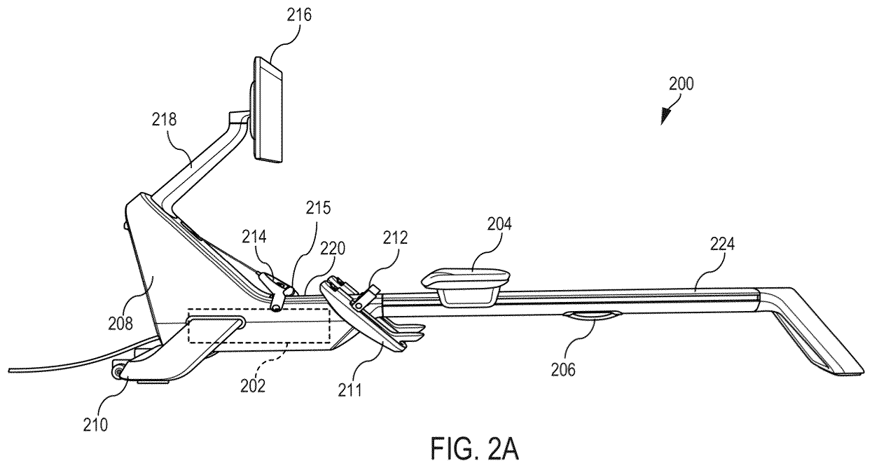

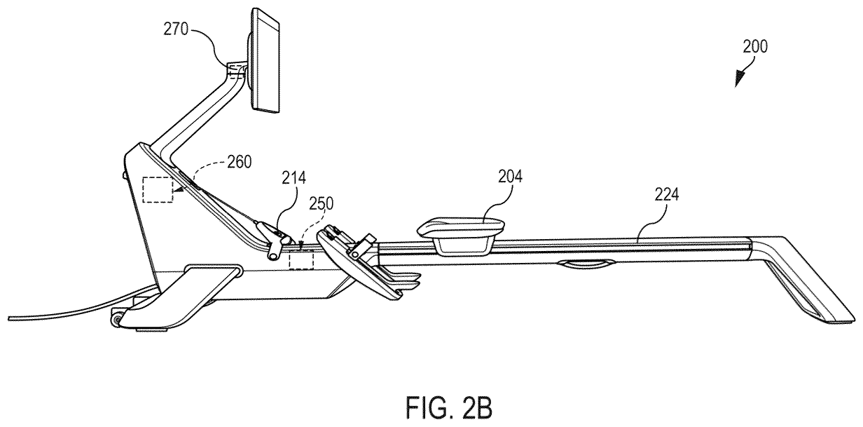

FIG. 2A depicts an example rowing machine 200, such as an exercise machine that simulates or supports a user performing a rowing activity on a boat or other water-based vehicle.

The rowing machine 200 includes a drivetrain 202, a seat 104, a rail handle 206, a hub 208 or housing, hub stabilizer wheels 210, a foot stretcher 211 (e.g., a pair of foot stretchers), a foot binding component 212, a handle 214, a handle mount 215, a display 216, a display mount 218, a storage compartment 220, and a rail 224 that extends out of the hub 208 upon which the seat 204 moves back and forth.

In some cases, the drivetrain 202, which is at least partially contained by the hub 208, positions a user in a rowing position, and may be parallel or substantially parallel to a horizontal surface, such as a floor. The drivetrain 202 can include a power absorber and electronic controls. Further, the drivetrain 202 can include or provide magnetic damping (e.g., providing quiet operation), a mechanically adjustable drag factor, and/or a software adjustable drag factor, which causes a user (e.g., the user 105) to feel a simulated rowing experience when pulling and/or holding the handle 214 during a rowing activity.

The drivetrain 202 can include a flywheel or other rotating mass, such as a steel disc or wheel. In some cases, the drivetrain 202 can include a belt tensioner and/or be hydro driven. Thus, in some cases, the drivetrain 202 operates to convert linear movement of the handle 214 (coupled to the drivetrain 202 via a strap, rope, cord, and/or chain) to rotary motion of a rotating device (e.g., flywheel or other rotating mass) of the drivetrain 202.

The rail 224 (or rails) can be part of the drivetrain 202, coupled to the drivetrain 202 or the hub 208, and/or positioned proximate to the drivetrain 202 or the hub 208. In some cases, the drivetrain 202 and/or the rails 224 may be detachable from the hub 208 for transport, storage, or other factors.

In some cases, the seat 204 attaches to the rail 224. The seat 204 slides horizontally on top of the rail 224 (e.g., along the rail 224) during a rowing activity performed by a user. For example, the user can apply a force when they begin rowing (e.g., the user pushes off with their feet to move away from the hub 208 or pulls back to move back towards the hub 208). The seat 204 can be ergonomic and stable.

Further, the seat 204 can include a position lock (e.g., a rotating lever and a rubber bumper) that locks the seat 204 to the rail 224 (e.g., when the rowing machine 200 is being stowed or moved). The seat 204 can also be set to an over-center or detent stop position, and can include spring-to-open feature, where the user can slide the lever from one side to the other to lock or unlock the seat 204 or saddle at any position along the rail 224.

The rail handle 206 is attached to a bottom portion of the rail 224, such as at a rear area of the rail 224 (near the rear end of the rowing machine 200). In some cases, the rail handle 206 is curved, such that the end of the rail handle 206 may connect to the bottom or side of the rail 224 to form an opening between the rail handle 206 and the rail 224. In some cases, the rail handle 206 assists in transporting the rowing machine 200 from one location to another and/or to lift (e.g., pivot) the rowing machine 200 to a vertical orientation.

Thus, the rail handle 206 is positioned near the rear end of the rail 224 to provide a user with leverage when lifting the rear end of the rail 224 upwards to orient the rowing machine 200 vertically place or to storage. As is described herein, the rowing machine 200 can be positioned in the vertical or upright orientation and fixed to a wall or other vertical surface.

In some cases, the hub 208, or housing, (at least partially) contains the drivetrain 202 or is otherwise positioned proximate to the drivetrain 202. The hub 208 can support the display 216 via the display mount 218 and can be detachable from the rail 224 or display 216. The hub 208 can be formed of a certain geometry and/or weight (relative to the entire machine 200) such that the hub 208 provides a stable base when the rowing machine 200 is positioned or oriented vertically. Further stabilizer wheels 210 (attached to feet) can assist in moving and/or lifting the rowing machine 200, as well as stabilizing the machine 200 when upright.

The foot stretcher 211 is configured to secure the feet of a user during a rowing activity. For example, the foot stretcher 211 can be a pair of stretchers and is disposed near the front of the rail 224. As described herein, the foot stretcher 211 can include a spring-loaded mechanism that facilitates a one-handed adjustment of each stretcher when the user inserts/removes a foot into/from the stretcher. The foot stretcher 211 includes a foot binder 212 to secure the foot in place.

The handle 214 is coupled or connected to the drivetrain 202 and/or hub 208 via a cable, rope, strap, chain, or other physical connection. The handle dock 215 is configured to dock the handle 215 when not in use and/or to reset tracking/monitoring of a rowing activity when the handle 214 is docked or otherwise proximate to the handle dock 215.

As is described herein, the handle 214 can include communication components, user controls, charging components, and so on. For example, the handle 214 can include components that interact with pogo pins of the handle dock 215 and/or a hall effect sensor of the handle dock 215, to charge the handle 214 and/or detect the proximity of the handle 214. Further, the handle 214 can include integrated controls that facilitate user navigation of content displayed by the display 216, adjustment of operation characteristics of the rowing machine 200 (e.g., an applied damping factor), and so on.

The display 216 is supported by the display mount 218, which attaches the display 216 to the hub 208 or housing. The display 216 can be a computing device that provides a user interface, such as tablet with a modular touch screen display. In some cases, the rowing machine 200 is associated with a portable computing device that provides a user interface, such as a smartphone, a watch, another display, a television, and so on.

As described herein, the display mount 218 can be a swivel mount that swivels up and down, and side to side up to a predefined number of degrees, such as 45 degrees. The display mount 218 can attach or support the display 216 on one end and attach to the hub 208 at the other end. In some cases, the display mount 218 includes a folding mechanism that facilitates the folding of the display 216 to a certain number of degrees (e.g., towards the rail 224) during storage, transport, set-up, and other functions when not in use for a rowing activity.

The storage compartment 220 is disposed near a front end of the rail 224 and proximate to the drivetrain 202 or hub 208, such as (at least partially) between the two stretchers of the foot stretcher 221. The storage compartment 220 can include compartments for storing various items or tools, such as compartments having a shape or geometry to store or receive a water bottle, a towel, and/or a mobile device. The storage compartment 120 can also include a charging mechanism or port (e.g., a USB port or an inductive charging platform) for charging the mobile device.

FIG. 2B depicts various sensors of the rowing machine 200. The rowing machine 200 can include a seat sensor 250 and a handle sensor 260. In some embodiments, the rowing machine 200 (e.g., the hub 208 or the display 216) includes a form system 270 (or form tracking system or form assist system), which can include various modules configured to perform actions based on input received from the sensors 250, 260.

In some embodiments, the form system 270 can receive information (e.g., position information) captured by the seat sensor 250 and/or the handle sensor 260, and determine a current form, or error in the form, of a user of the rowing machine 200 during one or more phases of a rowing stroke.

In some cases, the seat sensor 250 is a time-of-flight (ToF) sensor or camera (or other distance sensor and/or wireless sensor) that aims a laser or LED light signal along a rail (e.g., the rail 224) of the rowing machine 200 to the seat 204 to determine the position/velocity/acceleration of the seat 204 (along the rail 224) based on a time or duration of the light signal to travel to the seat 204 and reflect to the seat sensor 250.

In some cases, the handle sensor 260 is an encoder that measures a position/velocity/acceleration for the handle 214 based on a position or velocity or acceleration of a motor (e.g., the drivetrain 202) or other rotating mass coupled via a cable or chain to the handle 214. The motor or mass rotates as the handle 214 is pulled and released by the user, as described herein.

Thus, the form system 270 can be associated with a sensor system that includes the handle sensor 260 (e.g., an encoder), which tracks movement of the handle as the user performs different rowing movements (e.g., the catch, the drive, the finish, the recovery) and the seat sensor 250 (e.g., a distance sensor, such as a ToF sensor) that tracks movement of the seat 204. The form system 270 can utilize information from sensor system to determine whether the relative movement of the handle and the seat (e.g., the relative positions or velocities or accelerations at any given time or duration during a rowing movement) represent neutral, good, and/or bad form for the user, among other determinations.

In some embodiments, the sensor system may be calibrated and/or tested to ensure accurate measurements. For example, after running initial calibration routines, the accuracy and performance may be tested at various incremental distances before the user performs rowing activities. Sensor accuracy may be confirmed by observing linearity error bounds, as well as peak-to-peak signal noise. Further linearity errors can be reduced after recalibration by the user during or before initial activities.

The seat position is set to a known distance, and several measurements are taken. The linearity error measurement uses the average measured distance of the seat and compares the average against an ideal theoretical distance for the different calculated linear segments. The peak-to-peak noise measurement checks overall stability, as well as noise in the observed measurements, which is determined by computing the standard deviation in static distance measurements and bounding the observed results.

In some cases, the rowing machine 200 can include a camera or other image sensors that capture images of the user during rowing movements. The system can utilize the images to identify certain features of the user during a stroke, such as the curvature of a user's back, distances between different points on the user (e.g., between the eyes and shoulders of the user), and so on. The system can employ the relative position information and/or the imaging information with machine learning algorithms to generate predictions about the user's form, form errors, and so on. The camera or image sensors can be disposed within the display 216, the hub 208, the display mount 218, or other locations suitable for imaging the user during rowing activities.

Further, in some cases, the user may include or wear various sensors that capture data associated with seat and/or handle positions. For example, a user's watch or heart rate monitor may capture a position of the user's torso and/or wrist/hand, which can be similar to the position of the seat/handle. As another example, the user may wear a sensor as part of a shirt or shorts, which can also track the position of the seat (or torso of the user) during a rowing activity.

In some embodiments, other sensors can be distributed throughout the rowing machine 200 or be communicatively coupled to the rowing machine 200 or the display 216. For example, one or more sensors may be located inside or on the surface of the seat 204, the handle 214, the foot stretcher 211, the rail 224, and so on.

The group of sensors can include sensors that monitor or measure activity data, such as the simulated speed, cadence, and so on, of the rowing machine 200, capture video or images of the user using the rowing machine 200, measure user performance data, and/or measure user characteristics (e.g., a heart rate, respiration, hydration levels, and so on). The sensors may transmit the data to the rowing machine 200 (e.g., to the display 216), to other devices or machines, and/or to one or more servers or systems using wired or wireless connections, such as Bluetooth, HiD Remote, BLE HRM, Wi-Fi, and/or the Internet.

As described herein, the sensors can measure, track, or capture activity data of the user during a rowing activity performed via the rowing machine 200. In some cases, the various sensors are calibrated to accurately measure the activity data, such as based on usage or diagnostic information for the rowing machine 200 and/or a group of rowing machines associated with the connected fitness platform 100. Any of the sensors can include components programmed to generate error status and error codes when the sensors detect an error, and activity data, error status and/or error codes can be logged into a logging application included in the sensor and/or the rowing machine 200.

Thus, in some embodiments, the rowing machine 200 can include a drivetrain, a handle that is coupled to the drivetrain, a seat that moves along a rail, and a sensor system, including a seat sensor that is configured to detect a position of the seat along the rail and a handle sensor that is configured to detect a position of the handle. In some cases, the seat sensor is a ToF sensor disposed on a rail and captures distance information for the seat as the seat moves along the rail and the handle sensor is an encoder that captures rotation information for a flywheel, motor, or rotating mass of a drivetrain. The sensor system can transmit or send data to the form system 270, which determines a form of a user performing a rowing activity via the rowing machine based on the detected position of the seat along the rail in relation to the detected position of the handle.

### Examples of Performing Actions Associated with a Rowing Machine

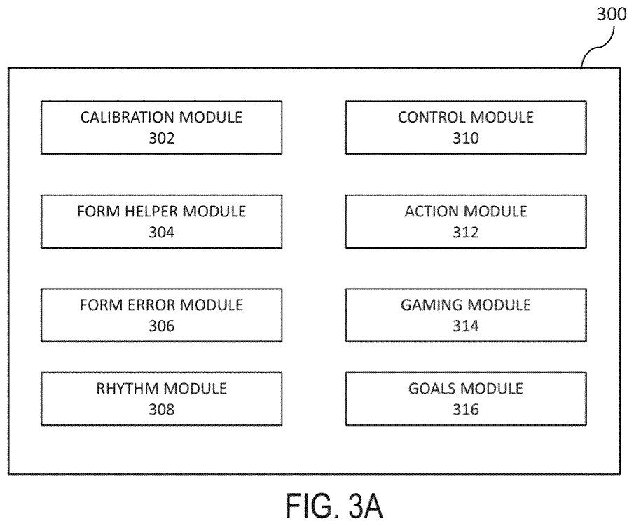

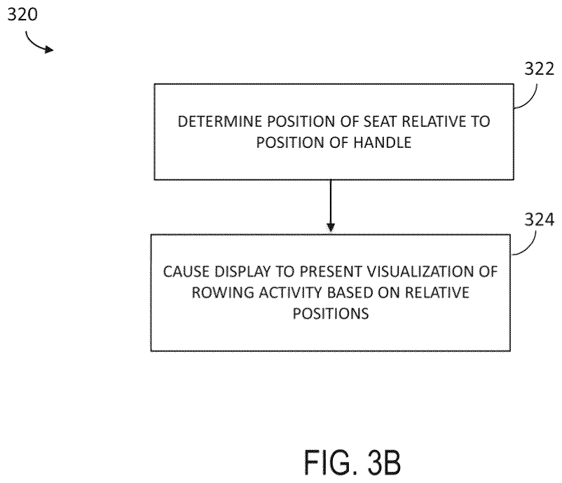

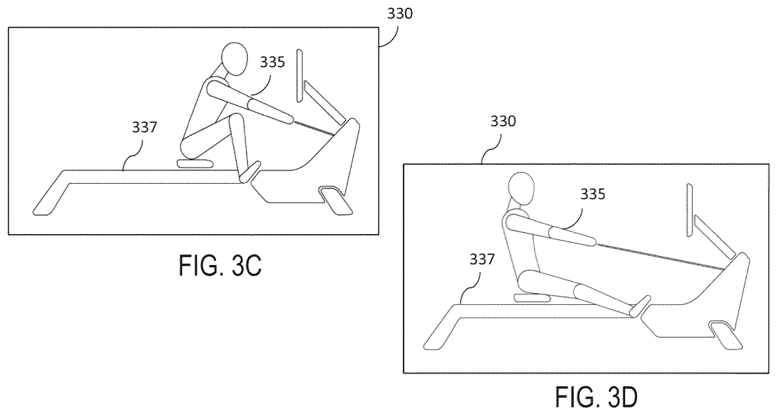

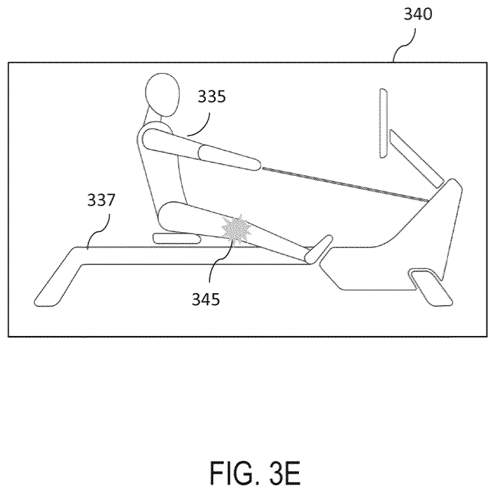

As described herein, in some embodiments, various systems or modules can perform actions based on information captured by the rowing machine 200 during a rowing activity of a user. FIG. 3A is a block diagram 300 illustrating various action modules of the rowing machine 200.

The modules of the rowing machine 200 can be implemented with a combination of software (e.g., executable instructions, or computer code) and hardware (e.g., at least a memory and processor). Accordingly, as used herein, in some example embodiments, a component/module is a processor-implemented component/module and represents a computing device having a processor that is at least temporarily configured and/or programmed by executable instructions stored in memory to perform one or more of the functions that are described herein.

In some embodiments, a personalized device calibration module 302 is configured and/or programmed to receive and process user input associated with the position data for user catch and finish positions. The personalized device calibration module 302 may store position data received from one or more sensors of the rowing machine 200 and can save the position data and other sensor measurements to a user profile for a user (e.g., rower) of the rowing machine 200.

In some embodiments, a form helper module 304 is configured and/or programmed to provide real-time feedback as a visualization of an avatar or other animation via the display 216. The real-time feedback can be based on a comparison of data from the seat and handle sensors with data associated with a known or proper form provided by a software algorithm and based on what is an optimal or suitable handle and seat position data for the user. For example, the proper form can be a form that results in a low amount of impact on the body during a workout. The form helper module 304 can cause the display 216 to present a visualization of how a user's current or recorded form deviates from the proper rowing form for the user.

In some embodiments, a form error module 306 is configured and/or programmed to provide real-time error classification of common rowing errors (e.g., the different parts if a stroke as described herein) based on user-calibrated values determined via a software algorithm. The errors can be based on handle and seat position data from the sensors. In some cases, the form error module 306 can also determine and/or provide post-class and/or post-activity error determination and guidance, as described herein.

In some embodiments, a rhythm module 308 is configured and/or programmed to provide a visual indication of a stroke output during a rowing activity based on a measured power of the user for each performed stroke. For example, the rhythm module 308 can receive sensor data that captures the rowing activity and generate or render a visualization that dynamically changes along with the movement of the user during the rowing activity.

In some embodiments, a control module 310 is configured and/or programmed to implement and perform a closed loop forward control system to control damping of the drivetrain 202, such as damping that applies a variable or constant damping factor to the drivetrain 202 during a rowing activity.

In some embodiments, a class module 312 is configured and/or programmed to enable responses or input to in-class events, such as via input received from a user via the handle 214 during the rowing activity.

In some embodiments, a gaming module 314 is configured and/or programmed to provide or present game-based rowing experiences via the display 216.

In some embodiments, a goals module 216 is configured and/or programmed to provide or present a user interface that displays information for a user, such as workout history information that compares workouts across different goals or events (e.g., a 2000-meter workout, 5000-meter workout, and so on).

As described herein, the form system or one or more of the action modules described herein can utilize data captured by sensors of the rowing machine 200 and perform actions using or based on the captured data. FIG. 3B is a flow diagram illustrating an example method 320 for performing an action using rowing machine data. The method 320 may be performed by the form system 270 or other action modules and, accordingly, is described herein merely by way of reference thereto. It will be appreciated that the method 320 may be performed on any suitable hardware.

In operation 322, the form system 270 determines a position of a seat relative to a position of a handle. For example, the form system 270 can receive data from the seat sensor 250, which is associated with a position of the seat 204 along the rail 224 and the handle sensor 260, which is associated with a position of the handle 214.

In operation 324, the form system 270 causes a display to present a visualization of the rowing activity based on the relative positions of the seat and handle. For example, the form system 270 causes the display 216 to present an avatar of the user rowing and/or a form helper visualization that depicts and/or identifies certain areas on a user that are compromised or causing form errors during the rowing activity.

As one example, FIGS. 3C-3D depict a visualization 330 of an avatar 335 representing a user on a rowing machine 337. The visualization 330 is rendered by the form system 270 and moves in sync with the user as the user performs a rowing activity via the rowing machine 200. As another example, FIG. 3E depicts a visualization 340 that identifies a form error 345 for the user via the avatar 335.

### Examples of the Form System

As described herein, the form system, 270, or form tracking system, can utilize position information for a seat and/or handle of the rowing machine to measure or track a form of a user when performing different rowing activities or movements using the rowing machine. For example, the form tracking system can include aspects of the form helper module 304 and/or the form error detection module 306, as described herein.

The form system can render, present, and/or display a graphical representation of a user performing a rowing activity, such as a dynamically changing graphical representation that is based on the data captured by the sensor system. For example, a combination of seat position data and relative position data (e.g., relative position of a seat to a handle) can be input into the user form system, which constantly or periodically updates a graphic or visual object (e.g., a moving avatar) that represents the user performing the rowing activity.

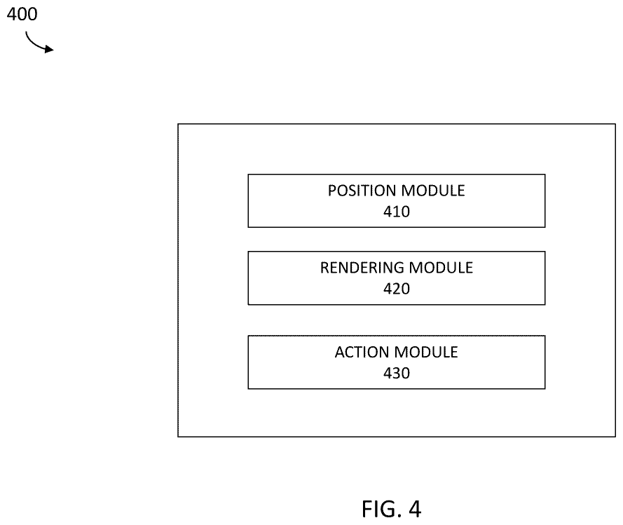

FIG. 4 is a block diagram illustrating components of a form system 400. The components and/or modules of the form system 400 (which can be supported or included by the form system 270) can be implemented with a combination of software (e.g., executable instructions, or computer code) and hardware (e.g., at least a memory and processor). Accordingly, as used herein, in some example embodiments, a component/module is a processor-implemented component/module and represents a computing device having a processor that is at least temporarily configured and/or programmed by executable instructions stored in memory to perform one or more of the functions that are described herein. The form system 400 includes a position module 410, a rendering module 420, and an action module 430.

In some embodiments, the position module 410 is configured and/or programmed to receive or access data from a sensor system of the rowing machine and determine a position or form of a user based on the data. For example, the position module 410 can receive data from a seat sensor and handle sensor and/based on received data, identify one or more form errors exhibited by the user or identify the current movement/position of the user during a rowing stroke.

In some cases, as described herein, the position module 410 can receive and/or determine the velocity/acceleration of the seat or handle of the rowing machine and identify the form errors or current movement of the user based on the velocity/acceleration (or relative velocity/acceleration) of the seat and handle.

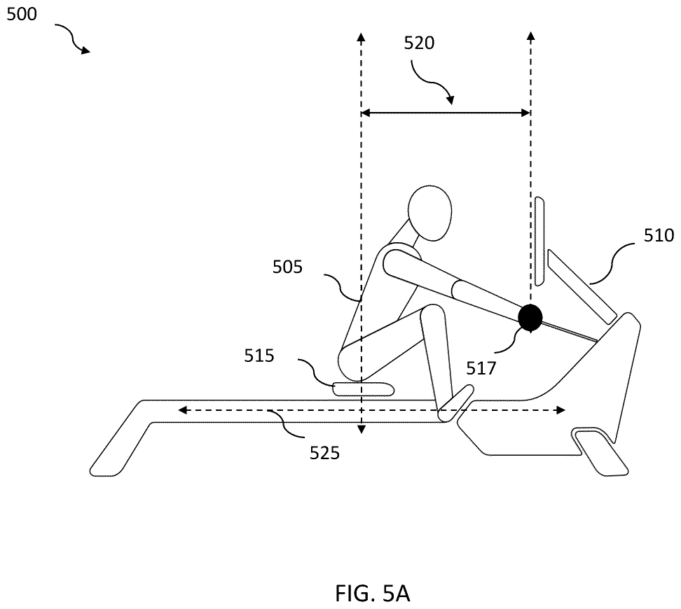

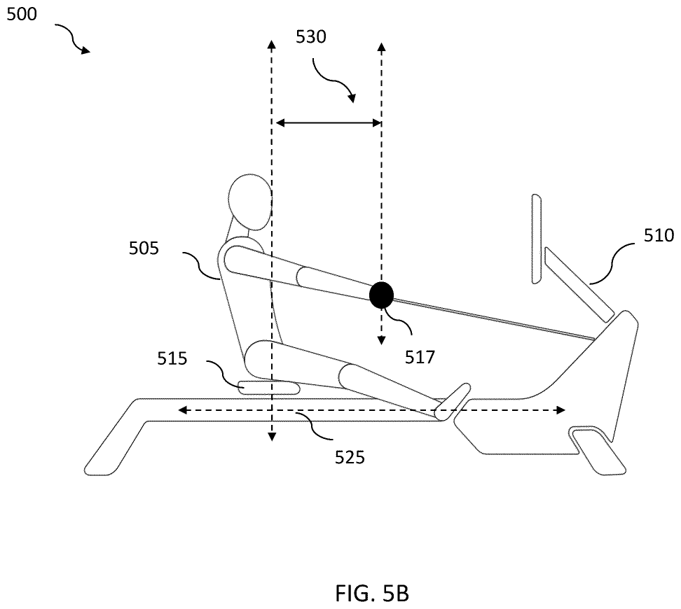

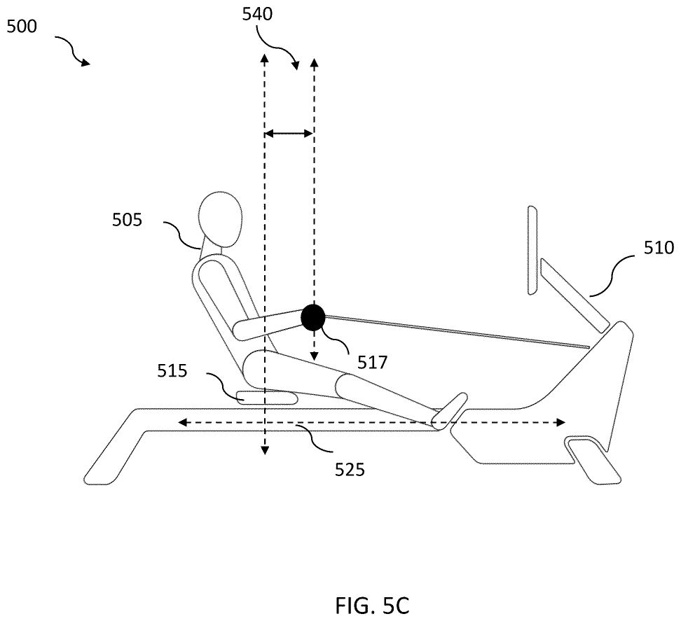

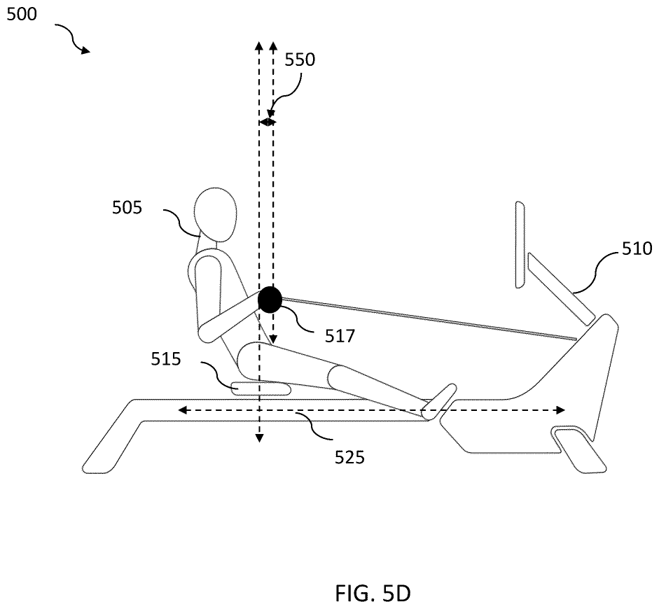

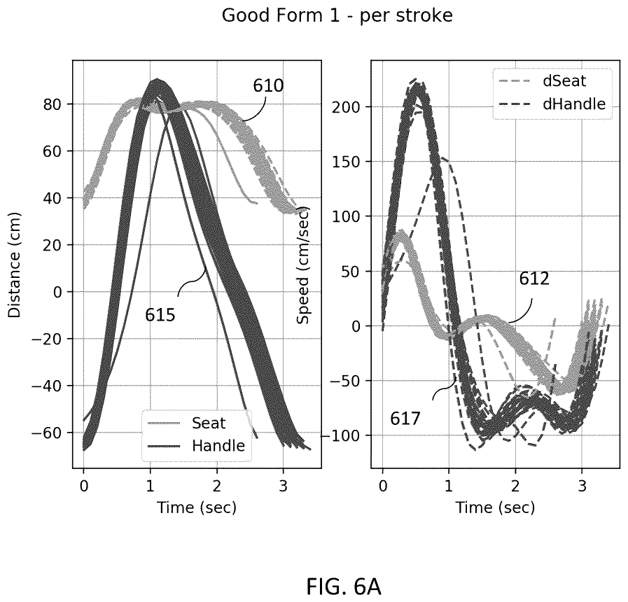

FIGS. 5A-5D are diagrams illustrating a user performing a rowing activity 500 using a rowing machine. As depicted, a user 505 on a rowing machine 510 performs an entire rowing stroke movement, including four phases-“the catch,” “the drive,” “the finish,” and “the recovery.” The user 505 sits on a seat 515 and pulls/releases a handle 517 during every performed rowing stroke.

The form system 400, via the position module 410, can measure and track a position of the seat 515 relative to a position of the handle 517 during each phase of the stroke. For example, the form system 400, in FIG. 5A, can measure a relative position 520 during the catch phase, a relative position 530, as shown in FIG. 5B, during the drive phase, a relative position 540, as shown in FIG. 5C, during the finish phase, and a relative position 550, as shown in FIG. 5D, during the recovery phase of the stroke.

Further, the form system 400 can track a position 525 of the seat, such as a linear distance from an initial point along a rail of the rowing machine 510. Thus, the form system 400 utilizes the relative position information 520, 530, 540, 550 and/or the seat position 525 to determine or identify errors in the form of the user 505, such as errors that reflect differences between a current form of the user 505 and an ideal, proper, baseline, and/or an acceptable form for the user 505.

In some embodiments, the form system 400 can determine different errors based on knowledge or context of the phase of the stroke in which the user is currently moving. For example, when the user 505 is in the finish phase, the form system 400 can utilize the relative position information 540 to determine whether the user is performing an over-extension or under-extension of the finish. As another example, when the user 505 is in the catch phase, the form system 400 can utilize the relative position information 520 to determine whether the user is performing an over-extension or under-extension of the catch.

Further, the form system 400 can determine various timing errors during the different phases using the relative position information. For example, the form system 400 can identify timing errors during a beginning (e.g., the first 20%) of a drive phase, such as bum shoving errors (shooting the slide errors), arm grabbing errors, and so on. Further details regarding the identification of errors and other form issues by the form system 400 will now be described.

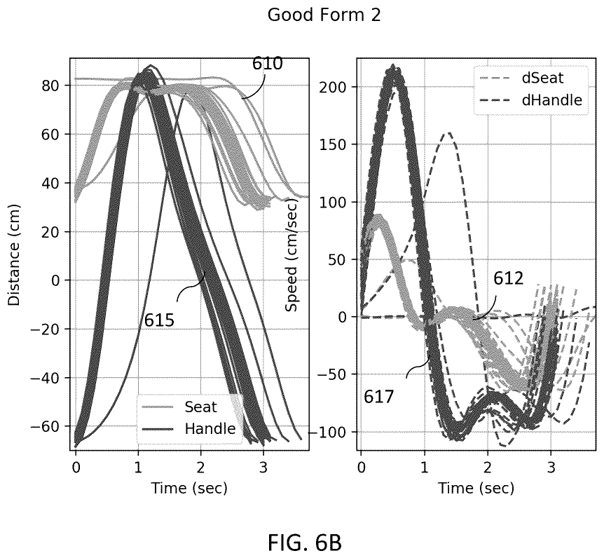

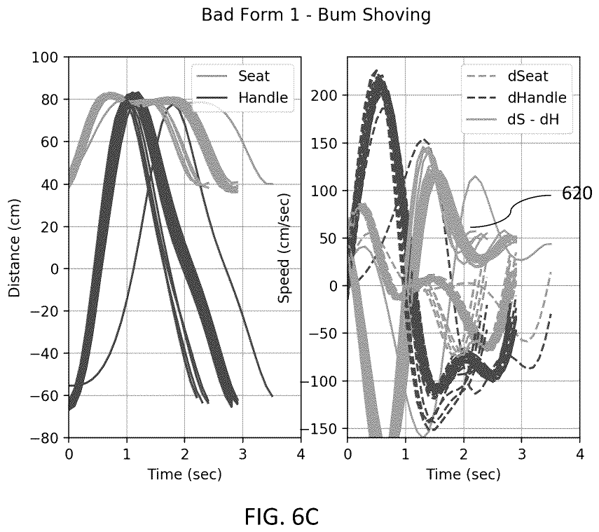

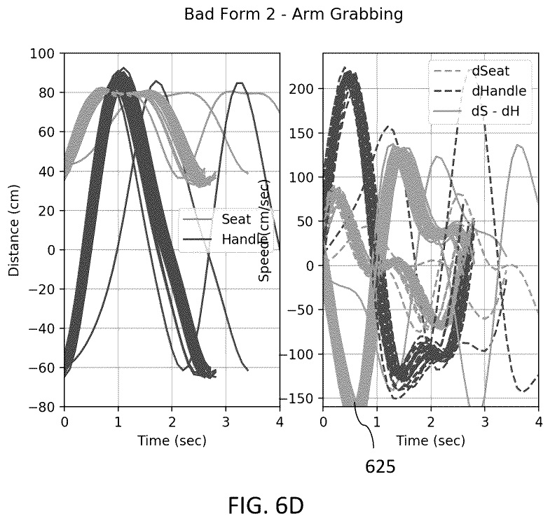

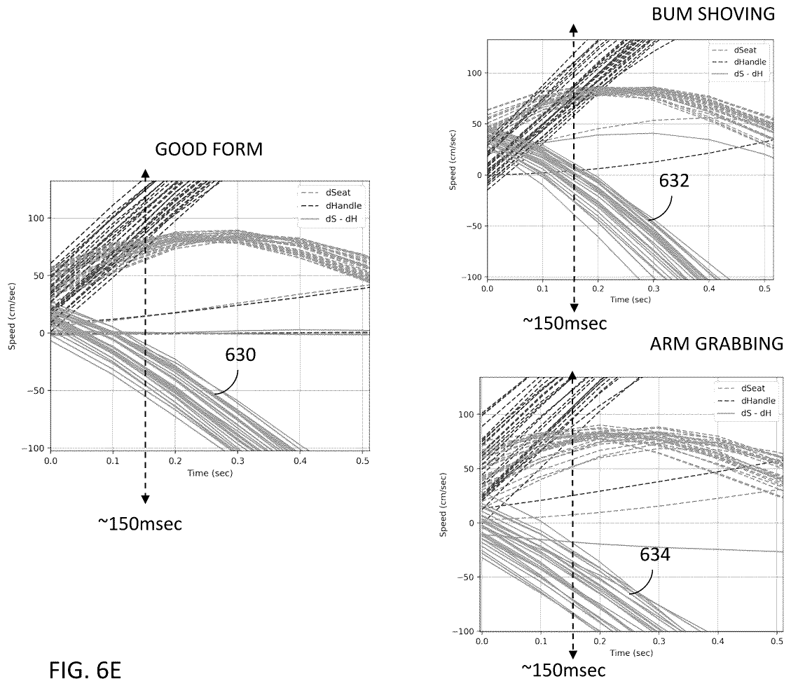

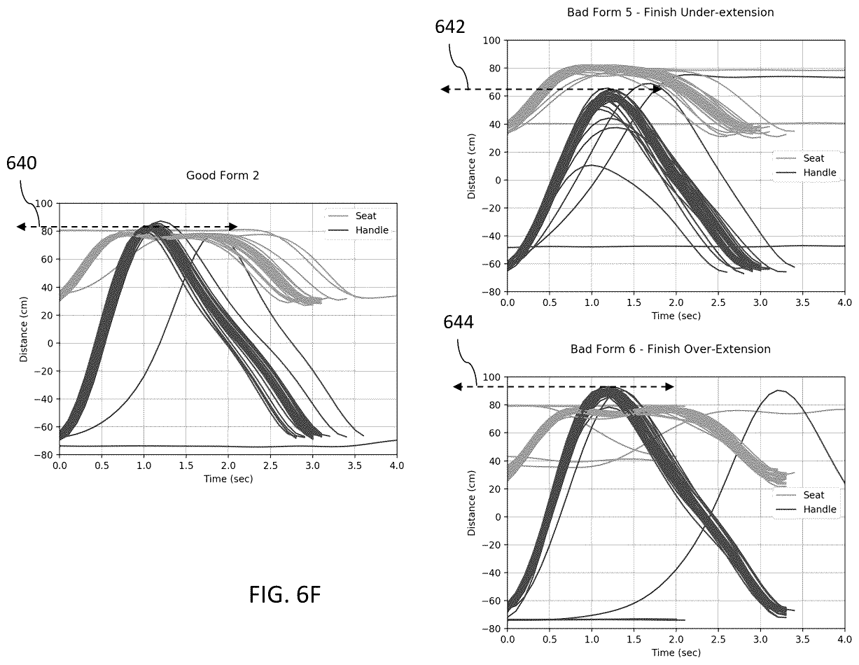

FIGS. 6A-6F are diagrams illustrating charts that map seat data to handle data for a rowing machine. The diagrams depict traces that relate seat position data and handle position data, as well as relative velocity data, to present or depict the identification of errors during a rowing stroke.

For example, FIGS. 6A-6B present charts that depict traces of seat position 610 and handle position 615, as well as seat velocity 612 (e.g., the derivative of the seat position 610) and handle velocity 617 (e.g., the derivative of the handle position 615) for several rowing strokes. The stroke is measured based on a horizontal axis that extends in a positive direction (e.g., 0 to 110 cm) from the feet of the user (e.g., at an initial point, or 0 cm) to the rear of the rowing machine (e.g., parallel to the rail of the rowing machine) and extends in a negative direction from the feet of the user to the front of the rowing machine. In some cases, the charts in FIGS. 6A-6B depict traces of the relative positions of the seat and handle that represent a user performing the stroke with a good or baseline form.

FIG. 6C presents a chart that depicts a “shooting the slide” error or “bum shoving” error (or similar error), reflected in a trace 620 that reflects the relative position of the seat to the handle. FIG. 6D presents a chart that depicts an “arm grabbing” error or similar error, reflected in a trace 625 that reflects the relative position of the seat to the handle during an initial drive phase period.

FIG. 6E presents a portion of the chart associated with the initial period of the drive, when, at a certain or distinguished time period (e.g., ˜150 msec), differences are reflected between a good form trace 630 and either a bum shoving error trace 632 or an arm grabbing error trace 634.

FIG. 6F presents a portion of the chart associated with the drive phase, which shows a good form distance 640 (set by the distance of the seat), an under-extension distance 642, and an over-extension distance 644. Thus, the form system 400 can identify speed or acceleration or timing errors for different phases of a stroke and relate the errors to errors associated with a user performing a rowing stroke incorrectly (e.g., having incorrect form, movement, and/or speed of movement). Of course, the form system 400 may generate and/or utilize charts or data representations not shown herein when determining errors during a rowing stroke performed by a user of a rowing machine.

Referring back to FIG. 4, in some embodiments, the rendering module 420 is configured and/or programmed to render, generate, and/or modify a graphical representation of the user based on the data received from the sensor system. For example, the rendering module 420 can render an avatar of the user, which includes graphical segments that represent different body parts of the user.

The graphical segments can include one or more graphical segments that represent a leg or foot of the user, one or more graphical segments that represent an arm of the user, a graphical segment that represents a head or neck of the user, a graphical segment that represents a torso of the user, and other configurations or depictions.

Thus, in some embodiments, the form system 400, via the rendering module 420, can render an articulated figure or avatar of the user based on the data captured by the sensor system. During a performed stroke, as the handle and seat position move, the angles at which the graphical segments are drawn update, which gives an effect of an animation tracking the user's position (e.g., both on the rowing machine and the body position as the user performs the stroke).

For example, the rendering module 420 can generate a graphical representation that view draws or creates the individual segments at appropriate angles relative to one another. As the user's form deviates from the correct form (e.g., as determined by the position module 410), the rendering module 420 may fade or overlay in a second representation (e.g., displayed behind the user's form), which illustrates the correct form. The overlay may be depicted in a different color, having an opacity that is relative to the magnitude of the user's rowing form errors, among other indicators.

The rendering module 420 may, in some cases, render the graphical representation as follows. First, feet are drawn, with the next segments being drawn at appropriate angles relative to the previous segment (e.g., a segment proximate to and/or connected to the segment), based on the position of the seat, as described herein.

For example, the rendering module 420 may linearly interpolate a lower leg angle (e.g., representing an ankle) within a range (e.g., 0-1), where a maximum angle is chosen to depict a correct angle (independent of the figure's geometry), and a minimum angle is calculated to represent a straight leg. Since it's not physically possible for a user to overextend the seat, we can disregard that case. Further, overcompression of the seat may be interpolated similarly across its own range.

The rendering module 420 may compute an upper leg angle (e.g., a knee) from the lower leg angle, to realize a consistent seat height. For example, assuming fixed lengths for the lower (ll) and upper (ul) legs and seat height (h), with a relationship between the knee angle (KA) and leg angle (LA), the knee height can be determined from either side, where ul sin (KA)+h=ll sin (LA), and solve for KA. The module 420 can perform a similar calculation to determine the minimum leg angle. For example, the seat moves farther as the angle decreases, but after a threshold (e.g. when the legs are straight), the seat will start moving closer as the knees bend backwards, and the legs can be considered a single segment of length ll+ul. Thus, position, can be represented as a single triangle, where (ll+ul) sin (LA)=h and solve for LA.

Next, the rendering module 420 may determine the arm and body/torse angles. Since the motion of the seat affects the handle position, the rendering module 420 may calculate upper angles based on the position of the handle relative to the seat, as described herein. The relative position may be divided into segments (e.g., arm segments and torso), corresponding to correct form by a user.

For example, a first half of the range from an upright position to a finish position is mapped to a range of back or torso angles, and a second half maps to a range of arm angles. The upper arm segments may have a fairly large range of motion to account for handle movement and the forearms may only have a small range of motion (e.g., 5 degrees). In some cases, any excess motion beyond the calibrated range may be added to the back angle. Further, the rendering module 420 may compensate for edge cases (e.g., extreme overextension) and modify the arm angles to prevent them from being depicted beneath the rail (e.g., such as when a user is performing unusual motions).

Thus, the rendering module 420 may render an articulated figure that animates or moves smoothly between the catch and finish positions of a stroke, mirroring the user's form and movement when performing a rowing activity.

In some cases, the rendering module 420 may depict each body segment as a line segment. For example, the segment lengths would define the kinematics of the figure, while the line thickness and end cap may create a two-dimensional effect.

In some cases, each body segment may be represented by one or more graphic assets that depict the body segment. The body segments, as animated, may overlap during rendering, and can be sized/tinted dynamically during presentation. The graphic assets may specify articulation points where the asset aligns with adjacent segments. In some cases, each asset is horizontal, and their articulation points, or pins, are aligned at the same y coordinate. To do so, a size of a bounding box and positions of the articulation points are determined.

For example, each asset may automatically scale to fit a specified bounding box for that asset. Further, the position of the asset is specified so that one of the articulation points is at the origin. Thus, the asset segment may be drawn by translating to the first articulation point, applying the rotation, drawing the asset, then translating to the next articulation point for the next asset.

For example, an asset may be fit into a width×height bounding box. Invariably, height=2×max(r₁, r₂), so, in this example, r₁=h/2. The box may be positioned with the origin on the first articulation point, so the lower left corner may be at position (−r₁, +h/2) and the upper left corner at (width−r₁, −h/2). For kinematics, this may be considered a line of length width−r₁−r₂.

Once appropriate bounding boxes are assigned to each asset, the rendering module 420 may replace the line segments with associated assets, and additional assets can be added to represent minor parts (e.g., parts not drawn) and/or other parts that don't move relative to other segments.

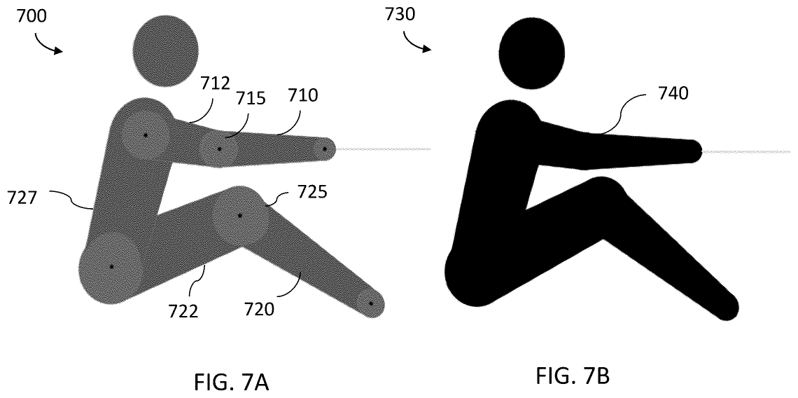

FIG. 7A depicts an articulated FIG. 700. The articulated FIG. 700, as generated by the rendering module 420, represents a point in time during a rowing stroke, and, as presented by a rowing machine, may be a dynamically changing graphic that mimics or depicts a user rowing on the rowing machine.

As described herein, the articulated FIG. 700 is rendered as a group of pinned segments. For example, the FIG. 700 includes a lower arm segment 710 that connects to an upper arm segment 715 via an articulation point 715 (e.g., representing an elbow that changes angle as the user performs a stroke). Similarly, the articulated FIG. 700 includes a lower leg segment 720 that connects to an upper leg segment 722 via an articulation point 725 (e.g., representing a knee that extends during the stroke).

The articulated FIG. 700 also includes a torso or body segment 727, rendered at an angle relative to a seat (and relative to the upper arm segment 712 and upper leg segment 722) as described herein. When displayed, the form system 420 may depict a graphical representation 730, as shown in FIG. 7B, having a unitary form 740 or color that hides the articulation points, resulting in a smoothly moving figure representative of the user performing the rowing activity. In some cases, the graphical representation 730 can have two or more colors, where a border of the graphic has a different color and/or can be tinted in a different shade.

While the articulated FIG. 700, depicted in FIG. 7A, includes a number of body segments, the rendering module 420 can render a figure or representation having more or fewer segments. The figure may include segments that represent a foot or feet, a neck, a rear, and so on.

For example, the foot may move through a fixed range of angles, starting from beig horizontal at the catch of a stroke and becoming more diagonal through the drive of the stroke. The lower leg angle range may not change, but its attachment point moves with as the foot rotates. As another example, the neck may be rendered as another segment attached to the torso or body, with an attachment point offset from the center of the torso. Thus, when the torso is leaning back, the neck and head rotate forward by half of the back angle, to keep the head facing forward. When the torso is leaning forward, the neck may be kept straight, and the head rotates by the reverse of the back angle.

Thus, as described herein, the rendering module 420 can utilize seat position information and/or relative position information (e.g., the position of the seat relative to the handle) as input to determining angles of connection between body segments of the articulated figure.

Referring back to FIG. 4, in some embodiments, the action module 430 is configured and/or programmed to perform an action based on the data captured by the sensor system. For example, the action module 430 may cause a graphical representation of the user to be presented during a performed stroke (e.g., generated by the rendering module 420), and/or present information that identifies and/or indicates an error in the user's form or movement, as described herein.

In general, a proper rowing form is less intuitive for a user (as compared to running or biking), such as for a user that is a beginner to rowing or other similar movements. Thus, the form system 400 can identify simple errors in the form of the user and present the error identifications to the user via an associated display or other presentations (e.g., audio or visual) of information. For example, the form system 400 can present an overlay of the measured form of the user to an ideal or proper form graphic, among other visual depictions of the error or recommended corrections.

In some embodiments, the form system 400, via the action module 430, may track and log form errors during a rowing activity (e.g., when a user is following an online or streamed rowing class). The action module 430 may store a database of form errors, which relate to a phase of the rowing stroke and an error condition.

An example error determination process is as follows:

First, stroke direction may be based on the direction of the handle, since the handle moves throughout the entire stroke, but may also be based on seat and handle movement direction for certain abnormal cases.

The form system 400 tracks the positions of the seat and handle until there is motion above a minimum threshold (e.g., above a small amount of motion due to seat jitter) and determines the overall stroke direction as a weighted average of the direction of each position. For example, the handle motion may be weighted about 4 times the seat motion to account for a larger range of actual motion of the handle during rowing.

Packets are then assigned to appropriate stroke segments/phases, such as the drive and recovery segments corresponding to most of the motion in the corresponding direction, while the catch and finish segments corresponding to the first packet after a direction change.

The form system 400 may perform error detection by iterating over a list of possible errors associated with a current stroke phase/segment, triggering an error when associated conditions are met. For example, the form system 400 may perform a check of three metrics (e.g., handle position, seat position, and relative position) are within a normal 0 to 1 range.

In some cases, the form system 400 may tune its error detection by adding or subtracting a small error margin e (e.g., tuned for each metric, where the error margin for relative position may be different than the margin for the seat position or handle position).

In some cases, the form system 400 may also capture the relative position when the stroke recovers or returns to 10% of its range and compare that relative position with the relative position at the catch, to determine a relative speed of the handle. In some cases, drive errors may only be detected at the beginning portion of the drive segment/phase, and the form system 400 may only detect errors within 20% of the stroke range.

The following table depicts a data structure that relates a form error to segments and error conditions:

TABLE 1

| Error | Segment | Condition | Location |
|---|---|---|---|
| Over compression | catch | Chain < −e | |
| | | Seat < −e | |
| Under | catch | Chain > e | |
| compression | | Seat > e | |
| Lunging at catch | catch | Chain < −e | |
| | | Speed > 0.1 | |
| Under extension | catch | Chain > e | |
| | | Relative > e | |
| Shooting the slide | drive | Relative < −e | Seat < catch |
| | | Seat > e | Chain < catch |
| Opening early | drive | Relative > e | Seat < catch |
| | | | Relative < catch |
| Too much layback | finish | Relative > 1 + e | |
| Too little layback | finish | Relative < 1 − e | |

Of course, other errors and/or conditions can be detected by the form system 400.

As described herein, in response to determining errors during a rowing stroke, the action module 430 may perform actions to indicate the errors to the user. For example, the action module 430 may display a red highlight or other indicator over body parts where the error is determined, such as a red gradient masked to an appropriate body part. Thus, the action module 430 can determine the error and the body part affected by the error (e.g., or causing the error), and present a visual indication of the error and/or its location during the stroke.

Thus, the form system 400, as described herein, can perform various processes or methods when tracking a rowing activity performed by a user of a rowing machine.

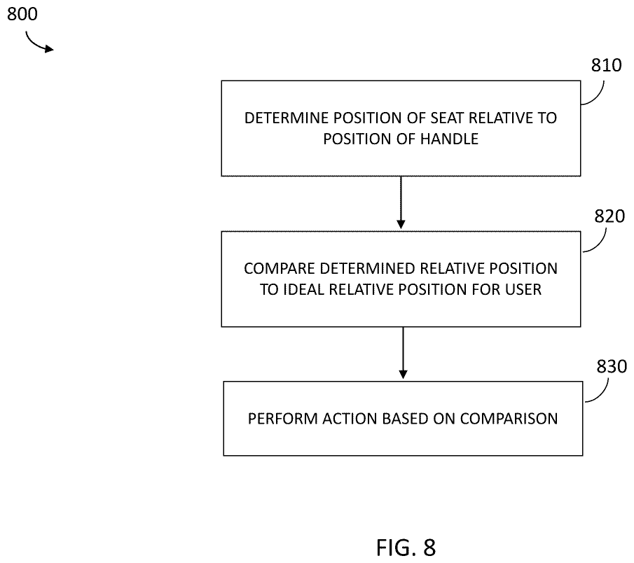

FIG. 8 is a flow diagram illustrating a method 800 for performing an action based on movement of a seat relative to a handle of a rowing machine. The method 800 may be performed by the form system 400 and, accordingly, is described herein merely by way of reference thereto. It will be appreciated that the method 800 may be performed on any suitable hardware.

In operation 810, the form system 400 determines a position of the seat relative to a position of the handle. For example, using information from the seat sensor and the handle sensor, the system can determine a relative position of the seat with respect to the handle during a stroke or one or more phases of the stroke.

In operation 820, the form system 400 compares the determined relative position to an ideal or proper relative position for a user of the rowing machine. For example, the form system 400 may utilize Table 1 to compare the relative position information during a segment to one or more error conditions.

In operation 830, the form system 400 perform an action based on the comparison. For example, the action module 430 may present an indication of the error via a display of the rowing machine (e.g., see FIG. 3E) and/or render and present a graphical representation of the user (e.g., see FIG. 7B) based on the comparison.

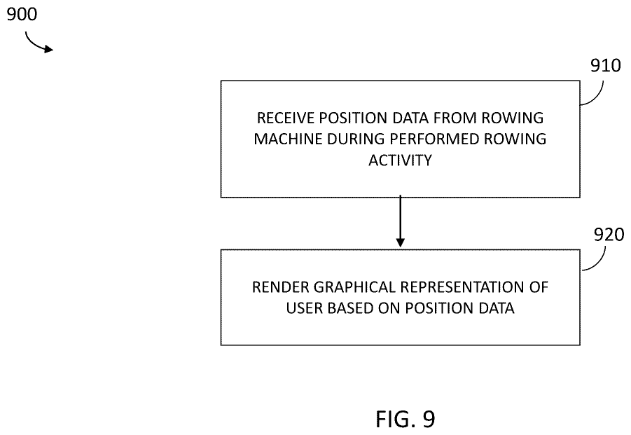

FIG. 9 is a flow diagram illustrating a method 900 for rendering a graphical representation of a user of a rowing machine. The method 900 may be performed by the form system 400 and, accordingly, is described herein merely by way of reference thereto. It will be appreciated that the method 800 may be performed on any suitable hardware.

In operation 910, the form system 400 receives data from a sensor system of the rowing machine. For example, the position module 410 may receive seat position data, handle position data, and/or relative position data.

In operation 920, the form system 400 renders a graphical representation of the user based on the data received from the sensor system. For example, the rendering module 420 can render a dynamically changing articulated figure as data is captured and provided to the position module 410.

In some cases, the graphical representation of the user is an avatar of the user and includes at least two graphical segments that represent a leg of the user, at least two graphical segments that represent an arm of the user, a graphical segment that represents a head of the user, and a graphical segment that represents a torso of the user.

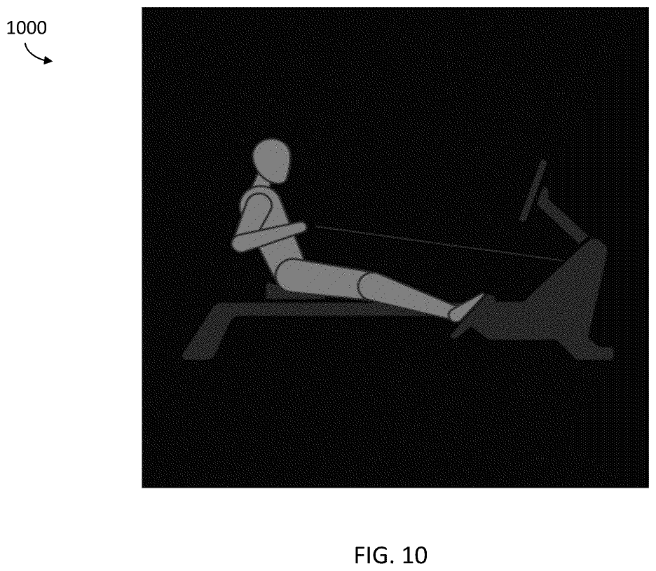

For example, FIG. 10 depicts a graphical representation 1000 of a user of a rowing machine having the various segments that move in relation to one another and based on data received from the rowing machine, as described herein.

### Example User Interfaces Presented During a Rowing Class

As described herein, in some embodiments, the rowing machine, via an associated user interface, presents information to users associated with a user's rowing stroke, movements, class performance, and so on.

Rowing classes, such as classes that provide instructions to many different rowers, can be different than other classes (e.g., running or cycling), because the intensity of the exercise is directly related to the effort of the user, whereas the treadmill can provide a speed/incline and/or the bike provides a variable resistance. For example, in a cycling class, the instructor calls for a target cadence and/or resistance resistance that maps to an expected output range. Similarly, in a running class, the instructor calls speed and incline numbers that map to ap expected output range.

On the other hand, an instructor, during a rowing class, may call out a strokes per minute (SPM) number, and possibly such additional information about how hard a rower should be exerting themselves (e.g., an RPE—Rate of Perceived Exertion).

Thus, when instructors cue or instruct an SPM and/or RPE, the user may not receive enough specificity or information to know how hard they should be pushing, whether they are properly following the instructor, and/or if they are achieving the goals of the workout. Thus, in some embodiments, the rowing class can include or employ pace targets, which give instructors a mechanism to clearly cue or instruct many different users, enabling the users to follow the class based on their own personal ability, as described herein.

For example, an effort (e.g., stroke rate) that is considered “challenging” to one rower can be vastly different (e.g., “easy” or “moderate”) to another user. Thus, instructors that cue certain segments or portions of a class based on pace targets, individualized to each member of the class, can contextualize the cues to the different members, at their individualized levels. The system can provide various user interfaces to facilitate such instructions or cueing, ensuring all class members experience a workout that is motivating and appropriately challenging to their level or class goals, among other benefits.

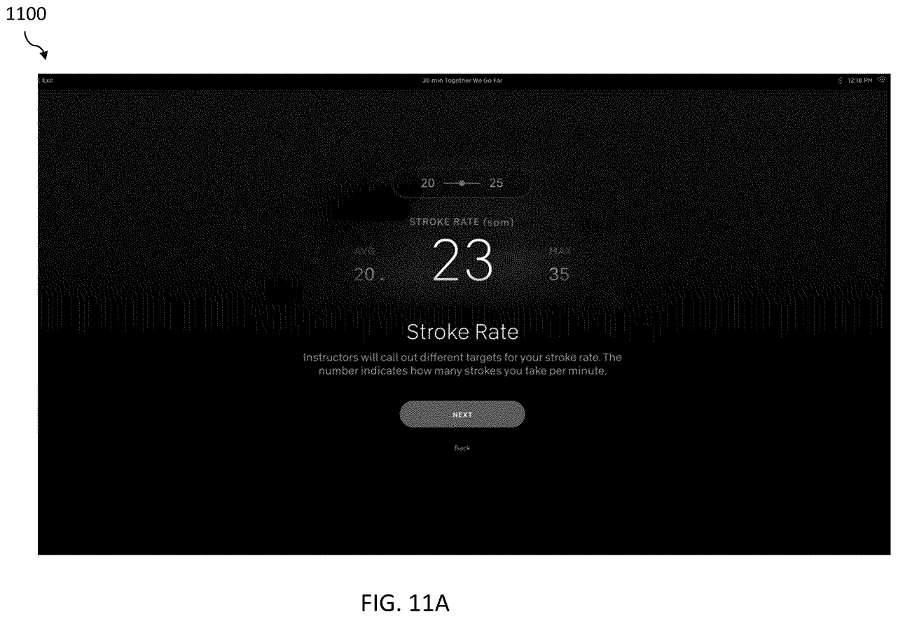

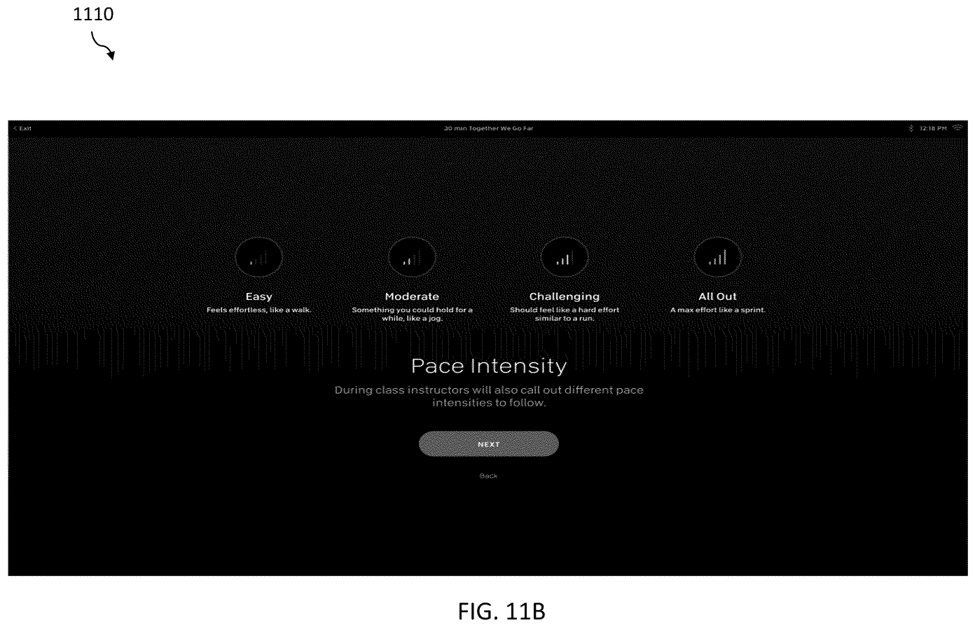

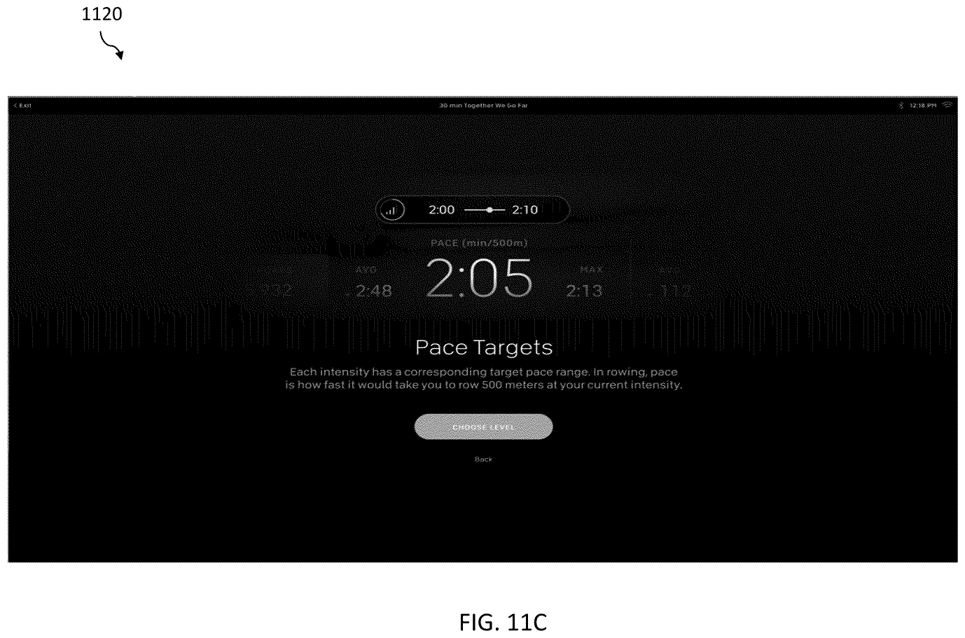

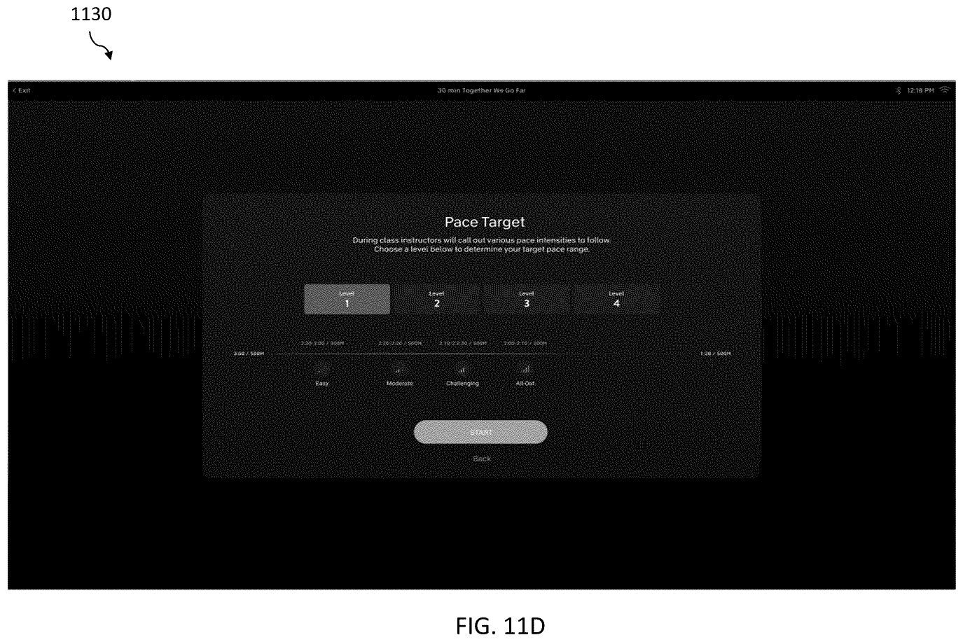

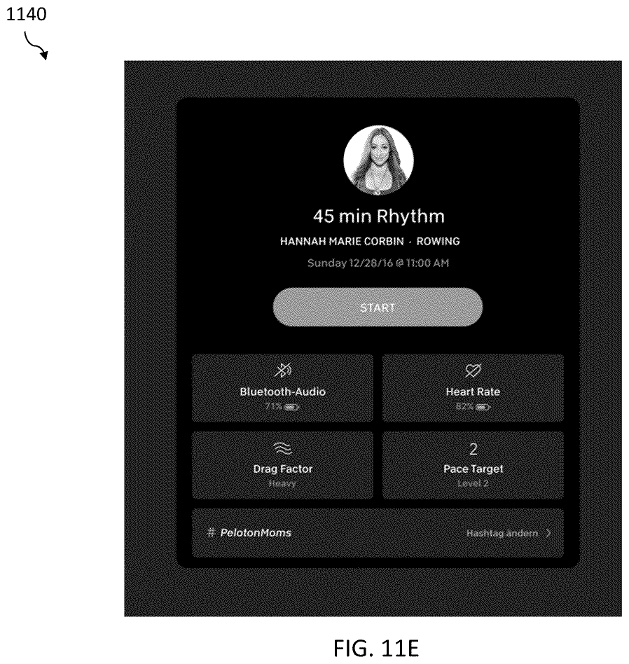

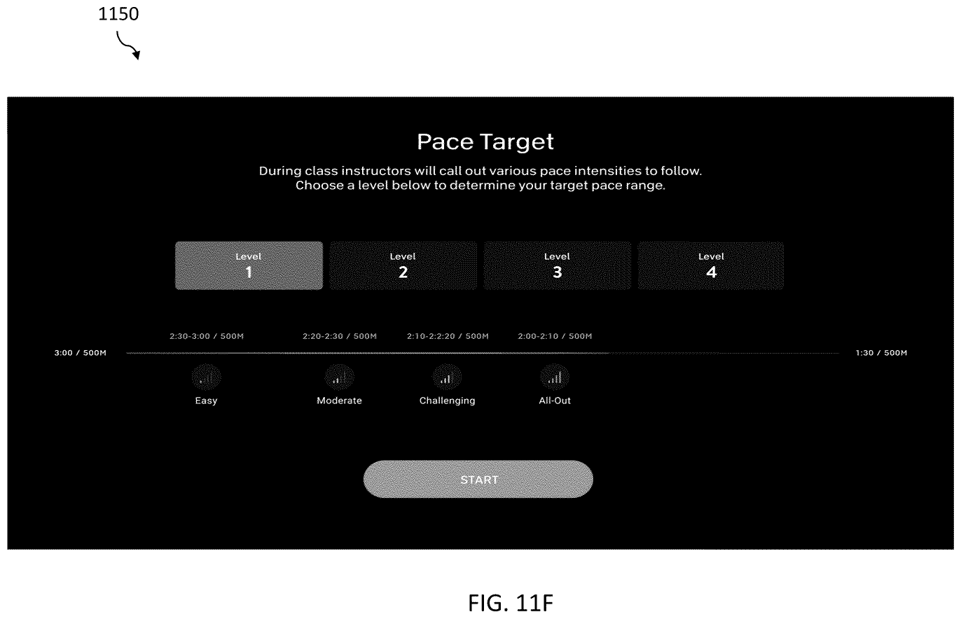

FIGS. 11A-11D present user interfaces that facilitate the onboarding of users to participate in a rowing class that presents cueing or other instructions via individualized pace targets. For example, FIG. 11A depicts a user interface 1100 presenting a stroke rate for a user within a target range. FIG. 11B depicts a user interface 1110 presenting different pace intensities for a user during a class. While the UI 1110 presents four levels of intensity (e.g., easy, moderate, challenging, and all out), other metrics can measure or represent different intensities (e.g., 1-10, 1-100, and so on).

FIG. 11C depicts a user interface 1120 presenting a pace target for a specific intensity. FIG. 11D depicts a user interface 1130 presenting different levels to apply to the intensities, so that a user can tune their workout to the different levels within each segment or movement of the class.

FIGS. 11E-11F present user interfaces shown to a user before a class starts. In FIG. 11E, a user interface 1140 enables a user to set their pace target level for the class. In FIG. 11F, a user interface 1150 enables the user to re-set, or re-select, a target level for the class.

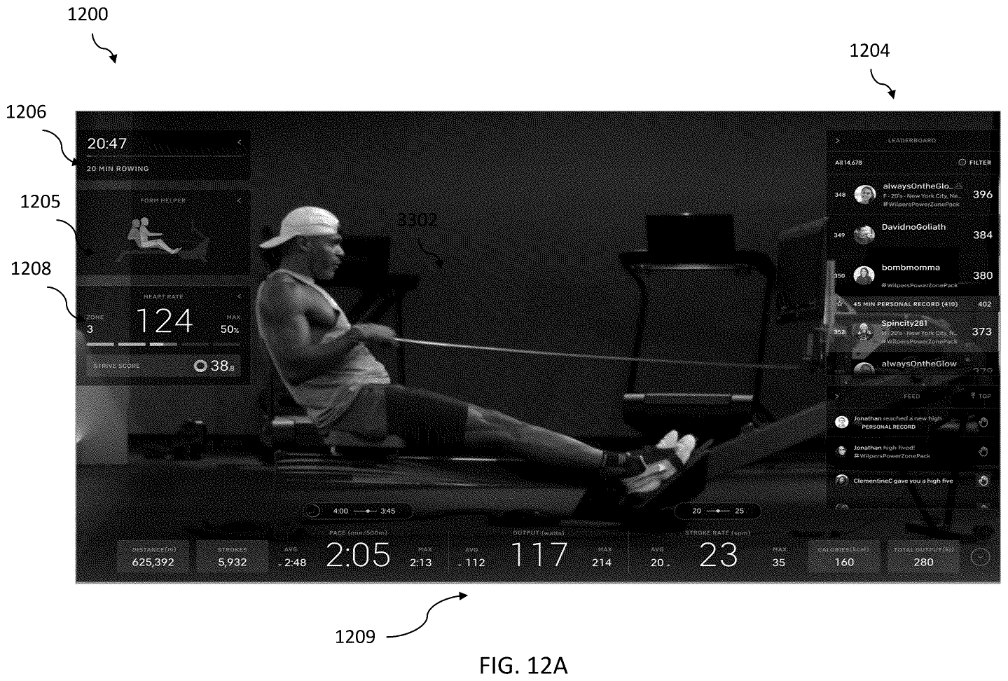

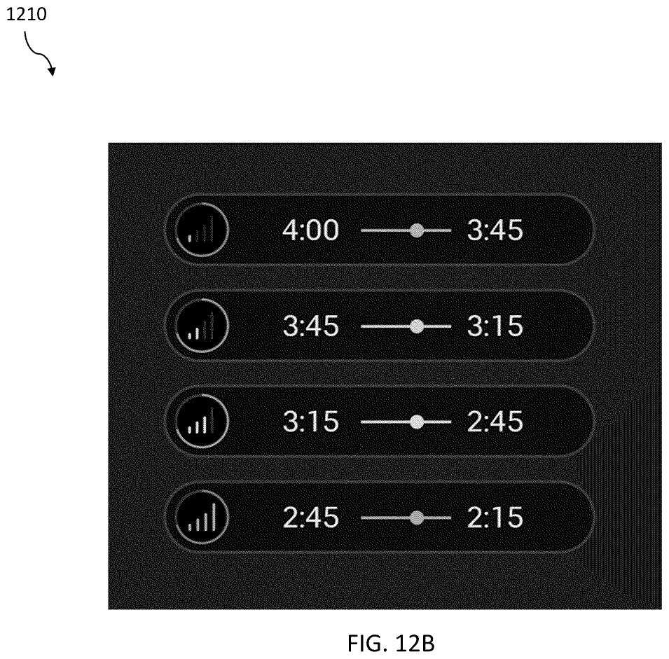

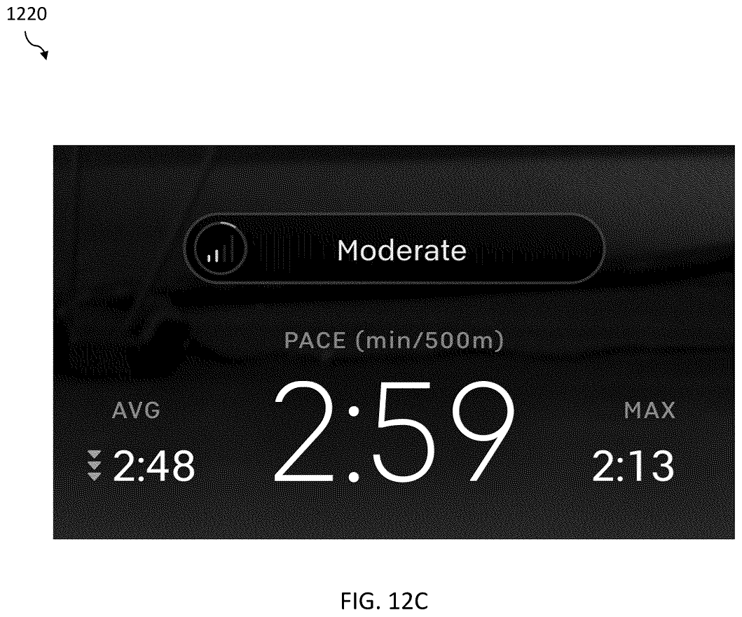

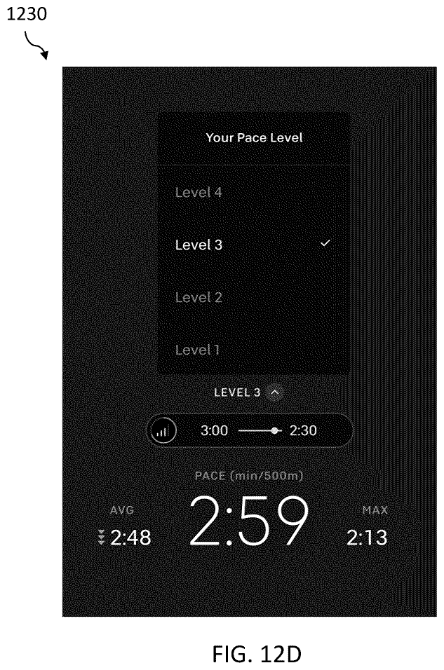

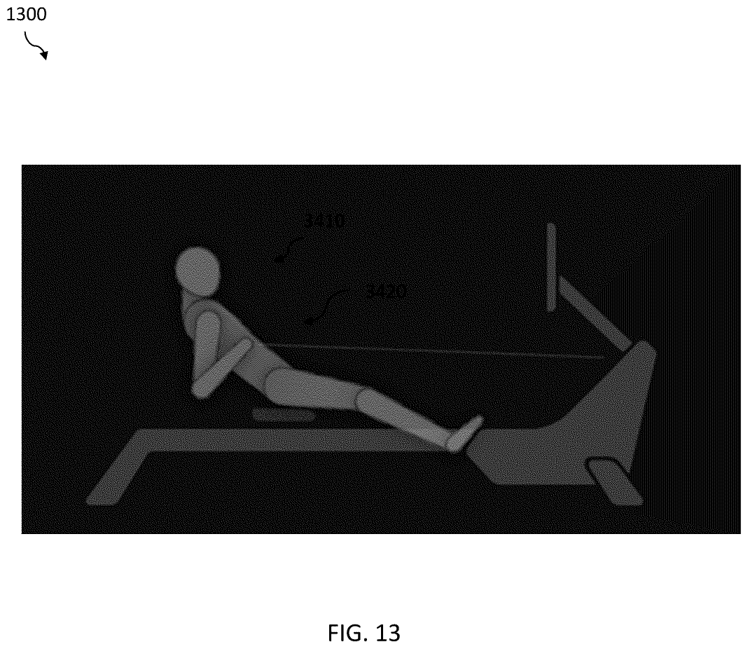

FIGS. 12A-12D present user interfaces displayed during a rowing class. For example, FIG. 12A depicts a screen 1200 displayed during an active rowing workout. The screen 1200 includes a display of an instructor 1202 performing rowing movements in the class, a list 1204 of class members (and/or a leaderboard or other dynamically updated list or ranking of members), a form helper 1205 interface that presents information associated with the form systems described herein (more details presented in FIG. 13), a movement timeline 1206 that presents class movement or segment information, a heart rate element 1208 that displays a user's heart rate and/or an intensity score (e.g., a strive score), and a class metric element 1209 that presents the user's stroke rate, the user's pace, the user's output, and other similar metrics.

Although not shown, in some cases the class user interface or screen 1200 can include various visual cues or guidance that moves, or changes, based on the user's stroke rate or stroke. For example, the screen 1200 can present a rhythm wave or other graphic that presents a dynamically changing graphic in sync with the user's movements during the class.

FIG. 12B depicts a user interface 1210 presenting pace ranges for different levels and instructor cues. For example, colors and bars of the UI 1210 can indicate an instructor's cue-for example, green and 1 bar=easy, orange=4 bar=all out. A ring element can indicate the amount of time spent in this cue, and all elements can provide guidance that shows whether a user is within a target or cued range.

FIG. 12C depicts a user interface 1220 that presents the user's pace within a specific range (e.g., “moderate”). For example, the UI 1220 can present an animation where the cue is shown before showing the range. FIG. 12D depicts a user interface 1230 that presents the user's current pace level and metrics associated with the level.

As described herein, the form system 400 can present a form helper or form assist graphic or display that identifies errors in the user's form during a rowing activity (as described here in). FIG. 13 presents a user interface 1300 where a user's movement is presented in a graphical representation 1310, along with an indication 1320 of an error in the form of the user (e.g., based on the position/pace/acceleration of the user and the time of the stroke and/or the phases of the stroke). For example, the user interface 1300 depicts a user, during a finish phase of a stroke, exhibiting an error associated with “too much layback” during the finish of the stroke, as shown by the highlighted body segments (e.g., torso, neck, upper leg) that are causing the error. Of course, other graphics or errors may be indicated, as described herein.

### Examples of the Disclosed Technology

In some embodiments, a method performed by a rowing machine includes detecting a position of a seat of the rowing machine relative to a position of handle of the rowing machine, determining whether a user of the rowing machine is exhibiting an appropriate rowing form based on the detected relative position of the seat to the handle during a rowing activity performed on the rowing machine, and performing an action based on the determination.

In some embodiments, the method includes identifying a rowing phase of the user currently being performed by the user and determining whether the user of the rowing machine is exhibiting the appropriate rowing form based on the detected relative position of the seat to the handle during the identified rowing phase.

In some embodiments, the method includes capturing the position of the seat of the rowing machine using a time-of-flight (ToF) sensor that tracks distance information for the seat as the seat moves along a rail of the rowing machine.

In some embodiments, the method includes capturing the position of the handle of the rowing machine using an encoder that measures rotation information for a chain of the rowing machine attached to the handle.

In some embodiments, performing the action based on the determination includes causing a display of the rowing machine to present information that identifies a current rowing form of the user, an appropriate rowing form for the user during a current rowing movement, and an indication of the determination of whether the user is exhibiting the appropriating rowing form.

In some embodiments, performing the action includes presenting a graphical representation of the user via a user interface of the rowing machine, where the graphical representation includes an indication of an error in the rowing form of the user during a rowing activity performed on the rowing machine.

In some embodiments, a method includes capturing a position of a seat of a rowing machine using a wireless sensor, determining a form of a user of the rowing machine based on the captured position of the seat of the rowing machine, and performing an action based on the determined form of the user of the rowing machine.

In some embodiments, the method includes capturing a position of a handle of the rowing machine, identifying a relative distance between the position of the handle and the position of the seat, and determining the form of the user based on the identified relative distance between the position of the handle and the position of the seat.

In some embodiments, a system for presenting a graphical representation of a user of a rowing machine via a user interface associated with the rowing machine includes a position module that receives data from a sensor system of the rowing machine and a rendering module that renders the graphical representation of the user based on the data received from the sensor system.

In some embodiments, the graphical representation of the user is an avatar of the user, and includes: at least two graphical segments that represent a leg of the user, at least two graphical segments that represent an arm of the user, a graphical segment that represents a head of the user, and a graphical segment that represents a torso of the user.

In some embodiments, the graphical representation of the user is an articulated figure that represents the user and includes multiple body segments pinned to one another via articulation points.

In some embodiments, the rendering module renders the graphical representation of the user by determining angles between body segments of the graphical representation of the user based on the data received from the sensor system.

In some embodiments, the graphical representation of the user includes at least one leg having a lower leg segment and an upper leg segment that are oriented at an angle relative to one another based on data received from the sensor system that identifies a position of a seat of the rowing machine.

In some embodiments, the graphical representation of the user includes at least one arm having a lower arm segment and an upper arm segment that are oriented at an angle relative to one another based on data received from the sensor system that identifies a position of a seat of the rowing machine relative to a position of a handle of the rowing machine.

In some embodiments, the graphical representation of the user includes at least one leg having a lower leg segment and an upper leg segment that are oriented at an angle relative to one another based on data received from the sensor system that identifies a position of a seat of the rowing machine, and at least one arm having a lower arm segment and an upper arm segment that are oriented at an angle relative to one another based on data received from the sensor system that identifies a position of a seat of the rowing machine relative to a position of a handle of the rowing machine.

In some embodiments, a method includes receiving data captured from a user performing a rowing activity at multiple times during the rowing activity, where the received data includes seat position data that represents a position of a seat upon which the user sits during the rowing activity and handle position data that represents a position of a handle held by the user during the rowing activity, and rendering a dynamically changing graphical representation of the user performing the rowing activity based on the received data.

In some embodiments, the graphical representation of the user is an articulated figure that includes: at least two graphical segments that represent a leg of the user, at least two graphical segments that represent an arm of the user, a graphical segment that represents a head of the user, and a graphical segment that represents a torso of the user.

In some embodiments, rendering the dynamically changing graphical representation of the user includes determining angles between body segments of the graphical representation of the user based on the received data.

In some embodiments, a rowing machine includes a sensor system that captures data from a user performing a rowing activity and a form system that renders a graphical representation of the user performing the rowing activity based on the captured data.

In some embodiments, the sensor system captures seat position data that represents a position of a seat of the rowing machine during the rowing activity and handle position data that represents a position of a handle of the rowing machine during the rowing activity.

### Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

1. A method performed by a rowing machine, the method comprising:
detecting a position of a seat of the rowing machine relative to a position of handle of the rowing machine;
determining whether a user of the rowing machine is exhibiting an appropriate rowing form based on the detected relative position of the seat to the handle during a rowing activity performed on the rowing machine; and
performing an action based on the determination.

2. The method of claim 1, further comprising:
identifying a rowing phase of the user currently being performed by the user; and
determining whether the user of the rowing machine is exhibiting the appropriate rowing form based on the detected relative position of the seat to the handle during the identified rowing phase.

3. The method of claim 1, further comprising:
capturing the position of the seat of the rowing machine using a time-of-flight (ToF) sensor that tracks distance information for the seat as the seat moves along a rail of the rowing machine.

4. The method of claim 1, further comprising:
capturing the position of the handle of the rowing machine using an encoder that measures rotation information for a chain of the rowing machine attached to the handle.

5. The method of claim 1, wherein performing the action based on the determination includes causing a display of the rowing machine to present information that identifies:
a current rowing form of the user;
an appropriate rowing form for the user during a current rowing movement; and
an indication of the determination of whether the user is exhibiting the appropriating rowing form.

6. The method of claim 1, wherein performing the action includes:
presenting a graphical representation of the user via a user interface of the rowing machine,
wherein the graphical representation includes an indication of an error in the rowing form of the user during a rowing activity performed on the rowing machine.

7. A method, comprising:
capturing a position of a seat of a rowing machine using a wireless sensor;
determining a form of a user of the rowing machine based on the captured position of the seat of the rowing machine; and
performing an action based on the determined form of the user of the rowing machine.

8. The method of claim 7, further comprising:
capturing a position of a handle of the rowing machine;
identifying a relative distance between the position of the handle and the position of the seat; and
determining the form of the user based on the identified relative distance between the position of the handle and the position of the seat.

9. A system for presenting a graphical representation of a user of a rowing machine via a user interface associated with the rowing machine, the system comprising:
a position module that receives data from a sensor system of the rowing machine; and
a rendering module that renders the graphical representation of the user based on the data received from the sensor system.

10. The system of claim 9, wherein the graphical representation of the user is an avatar of the user, and includes:
at least two graphical segments that represent a leg of the user;
at least two graphical segments that represent an arm of the user;
a graphical segment that represents a head of the user; and
a graphical segment that represents a torso of the user.

11. The system of claim 9, wherein the graphical representation of the user is an articulated figure that represents the user and includes multiple body segments pinned to one another via articulation points.

12. The system of claim 9, wherein the rendering module renders the graphical representation of the user by determining angles between body segments of the graphical representation of the user based on the data received from the sensor system.

13. The system of claim 9, wherein the graphical representation of the user includes at least one leg having a lower leg segment and an upper leg segment that are oriented at an angle relative to one another based on data received from the sensor system that identifies a position of a seat of the rowing machine.

14. The system of claim 9, wherein the graphical representation of the user includes at least one arm having a lower arm segment and an upper arm segment that are oriented at an angle relative to one another based on data received from the sensor system that identifies a position of a seat of the rowing machine relative to a position of a handle of the rowing machine.

15. The system of claim 9, wherein the graphical representation of the user includes:
at least one leg having a lower leg segment and an upper leg segment that are oriented at an angle relative to one another based on data received from the sensor system that identifies a position of a seat of the rowing machine; and
at least one arm having a lower arm segment and an upper arm segment that are oriented at an angle relative to one another based on data received from the sensor system that identifies a position of a seat of the rowing machine relative to a position of a handle of the rowing machine.

16-20. (canceled)

21. The method of claim 7, wherein performing an action based on the determined form of the user of the rowing machine includes rendering a graphical representation of the user based on the determined form of the user of the rowing machine.

22. The method of claim 21, wherein the graphical representation of the user is an avatar of the user, and includes:
at least two graphical segments that represent a leg of the user;
at least two graphical segments that represent an arm of the user;
a graphical segment that represents a head of the user; and
a graphical segment that represents a torso of the user.

23. The method of claim 21, wherein the graphical representation of the user is a dynamically changing graphical representation of the user.

24. The method of claim 21, wherein the graphical representation of the user is an articulated figure that represents the user and includes multiple body segments pinned to one another via articulation points.

25. The method of claim 21, wherein performing the action includes:
presenting the rendered graphical representation of the user via a user interface of the rowing machine,
wherein the graphical representation includes an indication of an error in the rowing form of the user during a rowing activity performed on the rowing machine.
